(19) United States
(12) Patent Application Publication
(10) Pub. No.: US 2012/0113542 A1
(43) Pub. Date: May 10, 2012

(54) OSCILLATOR IN WHICH POLARITY IS CHANGED AT HIGH SPEED, MAGNETIC HEAD FOR MAMR AND FAST DATA TRANSFER RATE HDD

(75) Inventors: Masukazu Igarashi, Kawagoe (JP); Yo Sato, Odawara (JP); Masato Shiimoto, Odawara (JP); Keiichi Nagasaka, Isehara (JP)

(73) Assignee: Hitachi, Ltd.

(21) Appl. No.: 13/287,292

(22) Filed: Nov. 2, 2011

(30) Foreign Application Priority Data
Nov. 8, 2010 (JP) 2010-249270

(51) Int. Cl. G11B 5/127; G11B 21/02

(52) U.S. Cl. 360/75; 360/125.12; G9B/21.003; G9B/5.04

(57) ABSTRACT

The present invention provides a magnetic recording head and a magnetic recording device that realize information transfer speed exceeding 1 Gbit/s in microwave assisted magnetic recording applied to a magnetic recording device having recording density exceeding 1 Tbit/in². Concerning a reference layer that supplies spin torque to a high-speed magnetization rotator serving as a microwave field generation source, when an externally applied field to the reference layer is represented as Hₑₓₜ, a magnetic anisotropy field of the reference layer is represented as Hₖ, and an effective demagnetizing field in a vertical direction of a film surface of the reference layer is represented as H_{d-eff}, the fixing layer is configured to satisfy conditions Hₑₓₜ−Hₖ+H_{d-eff}>0 and Hₑₓₜ+Hₖ−H_{d-eff}>0.

### CROSS REFERENCE TO RELATED APPLICATION

U.S. patent application Ser. Nos. 13/019,002 and 13/208,384 are co-pending applications of this application, the content of which are incorporated herein by cross-reference.

### CLAIM OF PRIORITY

The present application claims priority from Japanese patent application JP 2010-249270 filed on Nov. 8, 2010, the content of which is hereby incorporated by reference into this application.

### BACKGROUND OF THE INVENTION

1. Field of the Invention

The present invention relates to a magnetic recording head and a magnetic recording device for irradiating a high-frequency magnetic field on a magnetic recording medium to drive magnetic resonance, inducing magnetization switching of the recording medium, and recording information.

2. Background Art

With the improvement of performance of computers and the increase in speed and the increase in capacity of networks, the amount of information circulated in the form of digital data is dramatically increasing. In order to efficiently receive, distribute and extract such a large volume of information, a storage device that can quickly input and output the large volume of information is required. In a magnetic device, with the increase in density, a problem of a gradual decrease in a once-recorded signal due to thermal fluctuation becomes obvious. This is because a magnetic recording medium is a set of magnetic crystallites and the volume of the crystallites is decreasing. To obtain sufficient anti-thermal fluctuation stability, it is considered that a frequently-used thermal fluctuation index Kβ (=KuV/kT; Ku: magnetic anisotropy, V: particle volume, T: temperature, k: Boltzmann constant) needs to be equal to or larger than 70. If Ku and T (material, environment) are fixed, magnetization switching due to thermal fluctuation is more likely to occur in particles having smaller V. As the increase in density advances and the recording film volume occupied per bit decreases, V has to be reduced and the thermal fluctuation cannot be neglected. If Ku is increased to suppress the thermal fluctuation, a magnetization switching field required for magnetic recording exceeds a recording field that can be generated by a recording head. As a result, recording cannot be performed.

In order to prevent this problem, Microwave Assisted Magnetic Recording (hereinafter abbreviated as MAMR) is disclosed in US 2008/0019040 A1 (hereinafter, Patent Literature 1) by Zhu et al. of CMU. The MAMR is a technology for applying a microwave field from an adjacent Spin Torque Oscillator (hereinafter abbreviated as STO) to a magnetic recording medium having large magnetic anisotropy in addition to a magnetic field from a write pole of a vertical magnetic head to thereby change a recording target region to a magnetic resonance state and shake magnetization and reducing a magnetization switching field to perform recording (FIGS. 1A and 1B). This makes it possible to perform recording in a microwave irradiation region of a magnetic recording medium adapted to high recording density exceeding 1 Tbit/in² in which it is difficult to perform recording with a conventional magnetic head because a recording field is insufficient. The STO transmits spin torque from a reference layer to an adjacent Field Generation Layer (hereinafter abbreviated as FGL) via Cu and rotates magnetization of the FGL at high velocity in a plane to thereby generate a microwave (a high-frequency field). Since the MAMR makes use of a magnetic resonance phenomenon, an effective microwave field component is an anti-clockwise circularly polarized field in a rotating direction same as precession of recording medium magnetization. On the other hand, a microwave field from a Field Generation Layer (FGL), which is a microwave field generation source, of the STO is an ellipsoidally polarized field, a rotating direction of which depends on a magnetization rotation direction of the FGL, and rotates oppositely before and after the FGL. Therefore, the anti-clockwise circularly polarized field effective for the MAMR is generated only on one side before and after the FGL (FIG. 1B). Therefore, it is necessary to switch the rotating direction of the FGL every time write pole polarization is switched. The method of switching magnetization of a reference layer, which is a supply source of spin torque, according to a write pole field while fixing an STO driving current disclosed in JP 2009-070541 A (hereinafter, Patent Literature 2 which corresponds to US 2009/0052095 A1) and WO 2009/133786 A1 (hereinafter, Patent Literature 3 which corresponds to US 2011/0043943 A1) is realistic (FIGS. 2A and 2B). In this case, during the magnetization switching of the reference layer, since spin torque required for FGL driving is considered unable to be obtained, it is necessary to increase the velocity of the reference layer magnetization switching. A second conventional technology discloses a technology for reducing coercive force of the reference layer of the STO in the first conventional technology and switching the reference layer magnetization by the write pole field and a technology for setting a magnet having high magnetic flux density near the reference layer and increasing switching velocity. A third conventional technology discloses a technology for using a write pole or a part of an auxiliary pole substantially as a reference layer. A configuration is adopted in which a ripple portion is provided in the write pole, a high-frequency field generator is arranged via a spin scattering layer, and an electric current is fed such that spin torque works in a direction for suppressing the influence of a magnetic field from the write pole to the FGL. This configuration makes it possible to allow an inflow field from the write pole to the high-frequency field generator to vertically enter a film surface of the reference layer. Since the write pole is used as the spin source, it is possible to set a driving current for the high-frequency field generator, from which a maximum high-frequency field can be obtained without depending on the polarity of the write pole, according to a desired frequency.

### SUMMARY OF THE INVENTION

In the MAMR having recording density exceeding 1 T bits per one square inch, a strong high-frequency field is irradiated on a region of nanometer order, to which a write field from the write pole is applied, to locally change the magnetic recording medium to the magnetic resonance state and reduce a magnetization switching field to record information. The reference layer magnetization needs to be sufficiently fixed during oscillation of the STO and stable spin torque needs to be supplied to the FGL. Further, when the write pole polarity is switched, the rotating direction of the magnetization of the FGL needs to be switched. When the rotating direction of the magnetization of the FGL is not switched every time the write pole polarity is switched, a switching position of medium polarization shifts before and after the FGL and linear recording density cannot be increased.

In the technology described in Patent Literature 1, it is possible to irradiate a strong high-frequency field on a region of nanometer order to locally change the recording medium to the magnetic resonance state and reduce a magnetization switching field to record information. Since a multilayer film having high-magnetic anisotropy (and relatively low saturation magnetic flux density) such as (Co/Pd)n or (Co/Pt)n is used for the reference layer, stable spin torque is considered to be supplied to the FGL. However, since the reference layer magnetization is not switched according to the switching of the write pole polarity, to switch the rotating direction of the FGL magnetization, an STO driving current is switched. In this case, it is necessary to solve problems a) efficiency of spin torque changes according to plus and minus of an electric current, b) external fields applied to the FGL are not equal, c) rising angles of the FGL magnetization are different, and d) the STO driving current needs to be synchronized with the write pole field. Therefore, it is difficult to realize the technology.

In the technology described in Patent Literature 2, a multilayer film such as (Co/Pd)n or (Co/Pt)n having coercive force lower than that of a magnetic field from the write pole is used for the reference layer serving as a spin torque source. The magnetization of the reference layer is switched in synchronization with the write pole polarity while the STO driving current is kept fixed. Subsequently, the rotating direction of the magnetization of the FGL is switched. In the multilayer film such as (Co/Pd)n or (Co/Pt)n having low coercive force, magnetic anisotropy energy is small and saturation magnetic flux density Bₛ tends to be lower. Even if a high-Bₛ material is laminated, sufficient magnetization switching velocity for the reference layer is not obtained. Since the coercive force of the reference layer is low, when it is attempted to intensify an electric current and supply large spin torque to the FGL, the reference layer magnetization is made unstable by a reaction of the large spin torque. Further, in these multilayer films, since α is as large as 0.07 to 0.3, a spin current is consumed by a spin pumping action. Therefore, it is necessary to feed a large current for obtaining a high-frequency field of the same frequency.

In the technology described in Patent Literature 3, the ripple portion provided in the write pole is used as the spin torque source, whereby the magnetization of the spin torque source is switched in synchronization with the write pole polarity while the STO driving current is kept fixed. Subsequently, the rotating direction of the magnetization of the FGL is switched. Since the write pole or a part of the auxiliary pole is used substantially as the reference layer, the magnetization switching velocity is considered to be sufficiently high. However, the magnetization of the spin torque source tends to fluctuate because of the influence of a magnetization state of the write pole and the influence of the reaction of the spin torque from the FGL. Therefore, it is difficult to feed a large STO driving current and increase an oscillation frequency.

It is an object of the present invention to provide an information recording device suitable for ultrahigh-density and high information transfer speed recording that has high reliability and, as a result, reduces cost by realizing both 1) sufficiently high magnetization switching velocity of the reference layer of the STO and 2) sufficiently stable reference layer magnetization during oscillation of the STO.

For the purpose of solving the problems explained above, first, magnetization switching behavior was analyzed by a computer simulation based on a LLG (Landau Lifschitz Gilbert) equation described below.

$$( 1 + {α}^{2} ) \frac{d \vec{M}}{d t} = - γ ( \vec{M} \times {\vec{H}}^{′} ) , {\vec{H}}^{′} = \vec{H} + α \frac{\vec{M} \times \vec{H}}{M} \qquad ( 1 )$$

In the equation (1), γ represents a magnetomechanical ratio and α represents a damping constant. An effective field H is formed by a sum of four components: an inter-cell exchange field Hₑₓ, a magnetic anisotropy field Hₐ (=Hₖ×cos θₘ, θₘ is an angle formed by magnetization and a magnetization easy axis), a magneto static field H_{d}, and an external field Hₑₓₜ. Hₑₓ was calculated assuming exchange energy potential, an exchange stiffness constant of which was 1 μerg/m, proportional to a square of a shift in a magnetization direction between cells.

For an analysis of the magnetization switching of the reference layer, a reference layer having a size of 40 nm×40 nm×9 nm was divided by a cell having a diameter of 2.5 nm and height of 3 nm and regarded as an aggregate of 16×16×3 cells (FIG. 3). It is assumed that magnetization in the respective cells is uniform and is switched according to a simultaneous rotation model. The cells have substantially equal uniaxial magnetic anisotropies (dispersion±10%). As magnetization easy axis dispersion, a distribution of Δθ₅₀=3 deg. around a z axis was assumed. The external field Hₑₓₜ, the magnetic anisotropy field Hₖ, the saturation magnetic flux density Bₛ and the damping constant α were changed in a range of Table 1 and magnetization switching processes in combination conditions were calculated.

TABLE 1

| | |
|---|---|
| External field Hₑₓₜ (MA/m) | 0.4, 0.6, 0.8, 1.0, 1.2 |
| Anisotropy field Hₖ (MA/m) | 0.24, 0.48, 0.72, 0.96, 1.2, 1.44, 1.68 |
| Saturation magnetization Bₛ (T) | 0.6, 1.2, 1.8, 2.4 |
| Damping constant α | 0.01, 002, 0.03, 0.05, 0.075, 0.1, 0.2 |
| Stiffness constant A (μ erg/cm) | 1 |

As the calculation, first, an external field having planned intensity was applied in the z direction and, after a sufficient time, a predetermined external field was applied in a −z direction at 100 ps and left untouched, and the behavior of magnetization was observed (FIGS. 4A and 4B). A switching time of magnetization was calculated using time until an hour when magnetization of 90% of saturation magnetic flux density Bₛₒ is switched (a z component B_{sz} of magnetization reaches −0.9 BO with a point when a predetermined external field is applied set as the origin.

First, concerning a certain reference layer, an overview of magnetization switching behavior with respect to external field intensity is explained. FIG. 5 is a graph obtained by plotting the z component B_{sz} of magnetization on the ordinate and checking states of switching of reference layer magnetization of Bₛ=1.2 T and Hₖ=0.82 MA/m (9 kOe) by changing externally applied field intensity. An external field is applied substantially in the −z axis direction. A longest switching time is 230 ps at the externally applied field Hₑₓₜ of 0.6 MA/m (7.5 kOe). A shortest switching time is 120 ps at the externally applied field Hₑₓₜ of 1.2 MA/m (15 kOe). It is seen that the switching time is shorter as Hₑₓₜ is larger.

Then, an overview of magnetization switching behavior with respect to magnetic anisotropy field intensity in the case of fixed external field intensity is explained. FIG. 6A is a graph obtained by checking states of magnetization switching in the case of application of an external field of 0.6 MA/m (7.5 kOe) to a reference layer having Bₛ=1.2 T by changing the magnetic anisotropy field Hₖ. At Hₖ=1.68 MA/m (21 kOe), since magnetic anisotropy was too large and magnetization was fixed, switching of the magnetization in a range of a calculation time was not observed. At Hₖ=1.2 MA/m (15 kOe), a sign of magnetization switching was observed around time when the switching time exceeds 100 ps and the magnetization switching was completed at about 300 ps. Once switching starts, a ratio of a change in a z component of magnetization is not substantially different compared with the case of Hₖ=0.72 MA/m (9 kOe). It is considered that the start of the switching was delayed because reference layer magnetization is restrained near the magnetization easy axis by larger magnetic anisotropy. At Hₖ=0.24 MA/m (3 kOe), B_{sz}=0 at t=0. A phenomenon in which the reference layer magnetization was already switched nearly a half at this point was observed. This is considered to be because, since the influence of a demagnetizing field is larger than the influence of the magnetic anisotropy field, the reference layer magnetization topples in a plane when the externally applied field weakens. It is a point of short-time magnetization switching of the reference layer to increase the influence of the demagnetizing field and bring switching start timing forward. However, a magnetic film having Hₖ=0.24 MA/m (3 kOe) is unsuitable for the reference layer of the STO even if the start of switching is early. Since the demagnetizing field is too strong, the magnetization is not fully switched no matter how much time passes and does not reach a saturation state. When the magnetization of the reference layer is not saturated, a horizontal magnetization component remains. Spin torque in an unnecessary direction is given to the FGL. Since stability of magnetization of the reference layer itself is poor, the reference layer is made unstable by the reaction of the spin torque received by the FGL. As a result, oscillation is disordered. The phenomenon observed at Hₖ=0.24 MA/m (3 kOe) in which the magnetization was not fully switched although the start time of the switching was early (the z component B_{sz} of the magnetization does not reach −0.9 BO was also observed at Hₖ=0.72 MA/m (9 kOe) if Bₛ was set to 1.8 T at which the strength of the demagnetizing field increased (FIG. 6B).

As explained above, it was found that, for the reference layer served for the STO for MAMR, it is necessary to realize both 1) sufficiently high magnetization switching velocity and 2) complete switching and saturation of magnetization.

Therefore, in order to sort out results obtained in the magnetization switching calculation, a velocity factor V and a saturation factor S are introduced (FIGS. 7A and 7B). FIG. 7A is a diagram showing an effective field applied to the reference layer during the start of magnetization switching of the reference layer. A sum of effective fields acting on the reference layer is defined as the velocity factor V. The externally applied field Hₑₓₜ and an effective demagnetizing field H_{d-eff} accelerate the magnetization switching and positively act on the velocity factor V. However, it is assumed that, when a demagnetizing field coefficient in a direction perpendicular to the layer is represented as Nₚ and demagnetizing field coefficient in the layer direction is represented as Nᵢₙ, the effective demagnetizing field H_{d-eff} in a direction perpendicular to a film surface is given as a difference between a demagnetizing field NₚBₛ in the direction perpendicular to the film surface and a demagnetizing field NᵢₙBₛ in the film surface taking into account the shape of the reference layer.

H_{d-eff}(Nₚ−Nᵢₙ)×Bₛ (2)

When it is taken into account that the magnetic anisotropy field Hₖ acts to suppress the magnetization switching because the magnetic anisotropy field Hₖ faces the magnetization direction, the velocity factor V is represented by equation (3).

V=Hₑₓₜ−Hₖ+H_{d-eff} (3)

In FIG. 5, according to an increase in Hₑₓₜ, the velocity factor V increases and the magnetization switching time decreases. In FIG. 6A, in the case of Hₖ=1.68 MA/m (21 kOe), the velocity factor V is a negative value and the magnetization switching does not occur. It can be considered that, when Hₖ is smaller than 1.2 MA/m (15 kOe), the velocity factor V increases according to a decrease in Hₖ and timing for the start of the magnetization switching is early. It cannot be said that the reduction in the magnetization switching time and the early timing of the start of the switching are the same phenomena in the strict sense. However, since the switching is accelerated by both the reduction in the magnetization switching time and the early timing of the start of the switching, the reduction in the magnetization switching time and the early timing of the start of the switching are discussed as the same velocity factor V.

FIG. 7B shows an effective field applied to the reference layer during the end of the magnetization switching of the reference layer. As the saturation factor S, a sum of effective fields acting on the reference layer is defined. The saturation factor S is an effective field acting in causing the magnetization of the reference layer to reach saturation. The externally applied field Hₑₓₜ and the magnetic anisotropy field Hₖ positively act on the saturation factor S. Since the effective demagnetizing field H_{d-eff} faces a direction opposite to the magnetization, the effective demagnetizing field H_{d-eff} negatively acts on the saturation factor S.

S=Hₑₓₜ+Hₖ−H_{d-eff} (4)

In FIG. 5, since the reference layer magnetization reaches magnetization saturation even when the saturation factor S is the smallest Hₑₓₜ=0.6 MA/m (7.5 kOe), no change is observed in a state of the magnetization saturation even if the saturation factor S increases according to an increase in Hₑₓₜ. On the other hand, in FIGS. 6A and 6B, the saturation factor S decreases according to a decrease in Hₖ. In the case of Hₖ=0.24 (3 kOe), since the saturation factor S is a negative value, it can be interpreted that the reference layer magnetization does not reach saturation. In the case of Bₛ=1.8 T, since the effective demagnetizing field H_{d-eff} is large, even if Hₖ=0.72 MA/m (9 kOe), the saturation factor S is a negative value and the reference layer magnetization does not reach saturation. It is assumed that the effective demagnetizing field H_{d-eff} is given as a difference between a demagnetizing field NₚBₛ in the direction perpendicular to the film surface (Nₚ is a demagnetizing field coefficient in the direction perpendicular to the film surface) and a demagnetizing field NᵢₙBₛ in the film surface (Nᵢₙ is a demagnetizing field coefficient in the film surface). It is considered that, in the multilayer film such as (Co/Pd)n or (Co/Pt)n, which is a candidate of the conventional reference layer, the effect of an external field concerning magnetization saturation is not taken into account at all and, in general, Hₖ>H_{d-eff} is set as a requirement of the reference layer.

FIG. 8 is a graph obtained by plotting the saturation factor S on the ordinate and plotting the velocity factor V on the abscissa and summarizing calculated magnetization switching states concerning combinations of Hₑₓₜ (0.4 to 1.2 MA/m (5 to 15 kOe)), Hₖ=(0.24 to 1.68 MA/m (3 to 21 kOe)), and Bₛ=(0.6 to 2.4 T). A diamond indicates a condition under which the reference layer magnetization reaches magnetization saturation, a square indicates a condition under which the reference layer magnetization starts switching but does not reach magnetization saturation, and a triangle indicates a condition under which the reference layer magnetization does not rotate. When the velocity factor V is negative, the reference layer magnetization does not rotate (the triangle). When the saturation factor S is negative, the reference layer magnetization does not reach magnetization saturation (the square). It is predicted that the switching time is shorter as the externally applied field Hₑₓₜ is larger. However, according to FIG. 8, it is seen that, when the externally applied field Hₑₓₜ is fixed, the saturation factor S is smaller as the velocity factor V is larger. It is seen that, to increase the velocity factor V while securing the saturation factor S, it is necessary to increase Hₑₓₜ.

Dependency of the switching time on the velocity factor V is shown in FIG. 9. It is seen that the switching time is generally inversely proportional to the velocity factor V and, to obtain the switching time equal to or shorter than 0.2 ns, V needs to be equal to or larger than 0.7 (MA/m (8.5 kOe). However, attention needs to be paid to the fact that the calculation explained above is performed when the damping constant α is 0.1. It is known that a loss of energy is smaller and the magnetization switching time is longer as α is smaller. Dependency of the switching time on α is explained in detail in the next section. α of the reference layer material of (Co/Pd)n or (Co/Pt)n considered as the reference layer candidate to date is 0.07 to 0.3. α of a (Co/Ni)n multilayer film not considered as a reference layer material candidate for the STO because Hₖ is small and fixing force is weak is reported as 0.03 to 0.05. When reference layer materials having different damping constants α are used, it is necessary to take into account that a required velocity factor changes.

FIGS. 10A and 10B are graphs of dependency of the magnetization switching time, which is calculated with Hₑₓₜ=0.8 MA/m (10 kOe), Hₖ=0.63 MA/m (9 kOe), and Bₛ=1.2 T, on the damping constant α. In the figure, a switching time of single domain particles is also shown. The magnetization switching time of the reference layer increases according to a decrease in α. However, the increase is relatively gentle compared with that of the single domain particles. Under other various conditions, the magnetization switching time of the reference layer can be generally represented by equation (5) using a magnetization switching time t_{sw} (0.1) in the case of α=0.1.

t_{sw}(α)=t_{sw}(0.1)×(1−log₂(α/0.1)/2) (5)

For example, when a reference layer material, a of which is 0.025, is used, even if all the other conditions are the same, the magnetization switching time is considered to be about twice as long as that in the case of α=0.1. On the other hand, in the case of the single domain particles, the magnetization switching time suddenly increases in proportion to an inverse of α according to a decrease in α. From the viewpoint of the principle of damping, dependency of the magnetization switching time of the single domain particles on α is rather reasonable. It is estimated that, when α is small, another damping mechanism works for the magnetization switching of the reference layer.

Consequently, when a velocity factor for realizing a required reference layer magnetization switching time (required t_{sw}) in the reference layer having arbitrary a is represented as “required V(α)”, the required V(α) is represented as indicated by equation (6).

$$required V ( α ) = \frac{( 1 - {log}_{2} ( α / 0.1 ) / 2 )}{8 \times required {t}_{SW}} \qquad ( 6 )$$

FIG. 10B shows the required velocity factor (α).

FIGS. 11A and 11B are graphs showing, concerning the case of α=0.2 and 0.03, states of magnetization switching as magnetization components x, y, and z. When α is large, a z component of magnetization decreases and x and y components orthogonal to the z axis alternately increase. The magnetization of the reference layer is switched while rotating around a z axis generally uniformly. Behavior same as that of the single domain particles is shown. On the other hand, when α is small, the x and y components orthogonal to the z axis are hardly observed until B_{sz} reaches 0. This is estimated as a state in which magnetizations of the cells rotate substantially independently in an initial period of the magnetization switching of the reference layer. When the magnetizations of the cells rotate substantially independently, it is considered that, since an effective field from an adjacent cell largely fluctuates and the rotation of cell magnetization is modulated, damping is larger than that in the unified rotation of the entire magnetization of the reference layer. A change in B_{sz} until B_{sz} reaches 0 is steep. When frustration between adjacent cells is eliminated and the entire magnetization of the reference layer rotates uniformly, the x and y components of the magnetization alternately increase and a change in the z component decreases. The entire magnetization rotates uniformly when B_{sz} reaches 0. This is considered to be because, as shown in FIGS. 11C and 11D, the effective field from the adjacent cell changes between an initial period of switching (FIG. 11C) and an intermediate period of switching (FIG. 11D). In the initial period of switching, since an exchange coupling field Hₑₓ and the magneto static field H_{d} cancel each other in opposite directions, the magnetization rotates while keeping the relatively independent state. On the other hand, during the intermediate period of switching, it is considered that, since the exchange coupling field Hₑₓ and the average magneto static field H_{d} face the switching direction, the entire magnetization rotates uniformly. The reference layer is formed in a granular structure having a columnar shape extending in a film growth direction same as that of a Co recording medium and an exchange mutual action in a particle boundary is reduced by deposition of a nonmagnetic substance, it is possible suppress the unified rotation of the entire magnetization in the latter half of the switching and a reduction in the magnetization switching time is realized. The damping constant α of the reference layer is considered to be desirably large because the magnetization switching time decreases. However, when α is large, since spin is consumed by a spin pumping action, it is anticipated that an electric current cannot be fed to a current value for obtaining a high-frequency field of a required frequency. Therefore, the large damping constant α is undesirable. Rather, it is also an effective time reducing method of the reference layer magnetization switching to delay the integration of the reference layer magnetization.

Finally, a design guideline for the reference layer is examined. As explained above, the reference layer is required to have a fast switching characteristic and a saturation characteristic of magnetization. However, a most important function required of the reference layer of the STO is “magnetization is fixed and stable spin torque is supplied to the FGL”. A clear design guideline is required for design of the reference layer having seemingly contradictory characteristics: “easiness of magnetization switching” and “sufficient fixing of magnetization”. As a factor of “sufficient fixing of magnetization”, a fixing factor F is introduced as indicated by equation (7) using the saturation factor S.

F=BₛVₒₗ×S (7)

In the equation, Vₒₗ represents the volume of the reference layer. Therefore, the fixing factor F is considered to be an amount equivalent to magnetization energy of the reference layer present under the effective field of the saturation factor S.

FIG. 12A is graph showing both the velocity factor V and the fixing factor F with respect to Bₛ of the reference layer in the case of Hₑₓₜ=0.8 MA/m (10 kOe) and Hₖ=0.64 MA/m (8 kOe). An effective demagnetizing field coefficient Nₚ−Nᵢₙ is set to 0.671 taking into account the shape (40 nm×40 nm×40 nm) of the reference layer. The left ordinate indicates the velocity factor V and the right ordinate indicates the fixing factor F. The velocity factor V linearly increases according to an increase in Bₛ. This indicates that the magnetization switching is faster as Bₛ is larger. On the other hand, the fixing factor F has a shape convex upward with respect to Bₛ. The reference layer is most stable in an intermediate Bₛ value. This is because, when Bₛ is too large, in the tabular reference layer used for the STO, the effective demagnetizing field coefficient is positive, the demagnetizing field is strong, the saturation factor S is small, and the magnetization becomes unstable.

If a value of the velocity factor V for obtaining a required magnetization switching time is 1.36 MA/m (17 kOe), Bₛ required for the reference layer in this example is equal to or larger than 1.7 T. When a state in which Bₛ is slightly larger than 1.7 T is considered, the velocity factor V increases but the fixing factor F decreases to the contrary. If a value of the fixing factor F is sufficient, it is also conceivable to further increase Bₛ. Stabilization of the reference layer is extremely important in resisting the reaction of spin torque supplied to the FGL.

Slight tilting of a magnetic field applied to the reference layer from a direction perpendicular to the surface of the reference layer is examined (FIG. 12B). During switching, since magnetization and a magnetic field face opposite directions, an effective magnetic anisotropy field H_{k-eff} substantially decreases according to an increase in a field application angle (H_{k-eff-sw}) according to the Stoner-Wohlfarth law. On the other hand, during fixing, since magnetization and a magnetic field face substantially the same directions, H_{k-eff} gently decreases according to a cos side (Hk-_{eff-osc}). For example, when the field application angle is 10 to 20 degrees, it is possible to reduce only a magnetic anisotropy field during switching with little hindrance to a magnetization fixing action of the reference layer. This means that it is possible to increase the velocity factor V while keeping the saturation factor S and the fixing factor F by slightly tilting, from the direction perpendicular to the surface of the reference layer, the magnetic field applied to the reference layer. Alternatively, if Hₖ is increased not to change the velocity factor V, it is also likely that the fixing factor F can be increased by forty percent.

According to the above explanation, a velocity factor and a saturation factor obtained when the magnetic field applied to the fixing layer is tilted θ from the direction perpendicular to the surface of the reference layer are considered to be represented as indicated by equations (3) and (4).

V′=Hₑₓₜ−H_{k-eff-sw}+H_{d-eff}

H_{k-eff-sw}=Hₖ(cos^{2/3} θ+sin^{2/3} θ)^{3/2} (8)

S′=Hₑₓₜ+H_{k-eff-osc}−H_{d-eff}

H_{k-eff-osc}=Hₖ cos θ (9)

When the magnetic field applied to the reference layer has a distribution in the reference layer, an average of the magnetic field is used. When a switching state and switching velocity were calculated by changing θ, it was found that equivalent results were obtained even if the velocity factor V and the saturation factor S shown in FIGS. 8 and 9 were respectively replaced with V′ and S′.

However, when the magnetic field applied to the FGL tilts from the direction perpendicular to the surface of the reference layer, FGL magnetization tends to be restricted in the direction of the tilt. This is undesirable because oscillation (rotation of the FGL magnetization) is hindered. It is possible to evenly tilt the magnetic field applied to the reference layer by reducing pole width closer to the reference layer compared with pole width closer to the FGL.

Since magnetization is halfway during switching of the reference layer magnetization, it is likely that unnecessary spin torque is applied to the FGL. The influence of the unnecessary spin torque can be suppressed by temporarily weakening an STO excitation current in synchronization with switching time of write pole polarity. As a result, a stable STO oscillation characteristic can be obtained.

In a hard disk drive, bit length in a track direction is reduced according to an increase in surface recording density. In magnetic recording exceeding 1 Tbit/in², it is predicted that the bit length in the track direction is equal to or smaller than 10 nm. In this case, if 20 m/s, which is head-medium relative speed typically used in the present hard disk drive, is applied, recording is performed at 10/20=0.5 ns or less per one bit. In this case, information transfer speed is 2 Gbit/s. In the first to third conventional technologies, since a head field is perpendicularly applied to the recording medium, it is difficult to reduce a switching time for the recording medium to 0.4 ns or less. Therefore, it is difficult to realize information transfer speed exceeding 1 Gbit/s.

If a polarity switching time for the write pole is set to 0.1 ns, it is necessary to set the switching time for the recording medium to 0.2 ns or less and set the switching time for the reference layer to 0.2 ns or less. Under a predetermined condition in the present invention, the reference layer magnetization switching velocity can be reduced to 0.2 ns or less and the recording medium switching velocity can be reduced to 0.2 ns or less. Therefore, it is possible to attain a 1-bit writing time=0.5 ns. As a result, in an information recording device to which microwave assisted magnetic recording, recording density of which exceeds 1 T bits per one square inch, is applied, it is possible to provide a high-density information recording method and a high-density information recording device that realize information transfer speed exceeding 2 Gbit/s.

With the configuration explained above, it is possible to provide a magnetic head and a magnetic recording device suitable for ultra-high density and high information transfer speed recording that have high reliability and, as a result, reduce cost by realizing both of sufficiently high magnetization switching velocity of the reference layer and stabilization of the reference layer magnetization during oscillation of a spin torque oscillator.

### BRIEF DESCRIPTION OF THE DRAWINGS

FIG. 1A is a diagram showing the principle of MAMR.

FIG. 1B is a diagram showing a magnetic field generated from an FGL.

FIG. 2A is a diagram showing a relation among an STO, an external field, and the direction of an STO driving current.

FIG. 2B is a diagram showing a relation among the STO, the external field, and the direction of the STO driving current.

FIG. 3 is a diagram showing a calculation model of a reference layer.

FIG. 4A is a graph showing a temporal change of an external field used for calculation.

FIG. 4B is a diagram showing a temporal change of magnetization and a definition of a switching time.

FIG. 5 is a graph showing a temporal change of magnetization.

FIG. 6A is a graph showing a temporal change of magnetization.

FIG. 6B is a graph showing a temporal change of magnetization.

FIG. 7A is a diagram showing a relation of an effective field during the start of reference layer switching.

FIG. 7B is a diagram showing a relation of the effective field during the end of the reference layer switching.

FIG. 8 is a graph showing a state of switching.

FIG. 9 is a graph showing dependency of a switching time on a velocity factor.

FIG. 10A is a graph showing dependency of the switching time on a damping constant.

FIG. 10B is a graph showing a relation between a required velocity factor and the damping constant.

FIG. 11A is a graph showing changes in components of magnetization during reference layer magnetization switching (α=0.2).

FIG. 11B is a graph showing changes in the components of the magnetization during the start of the reference layer magnetization switching (α=0.03).

FIG. 11C is a diagram showing a state of an effective field applied to a certain magnetization element during the start of the reference layer magnetization switching.

FIG. 11D is a diagram showing a state of an effective field applied to a certain magnetization element when the reference layer magnetization generally faces a horizontal direction.

FIG. 12A is a graph showing a design guideline for a reference layer for an STO for MAMR.

FIG. 12B is a graph showing a change in an effective anisotropic field that occurs when an external field is tilted from a direction perpendicular to the surface of the reference layer.

FIG. 13 is an enlarged view of a magnetic head unit.

FIG. 14 is a graph showing dependency of a magnetic field, which is generated between poles, on an aspect ratio.

FIG. 15 is a graph showing a magnetic characteristic of (Co/Ni)n.

FIG. 16 is a graph showing a magnetic characteristic of a trial production magnet.

FIG. 17A is a graph showing a switching state of the reference layer calculated using parameters of the trial production magnet.

FIG. 17B is a graph showing a switching time of the reference layer calculated using the parameters of the trial production magnet.

FIG. 18 is a diagram showing a form of placing a magnetic head on a magnetic head slider.

FIGS. 19A and 19B are diagrams showing forms of placing the magnetic head on the magnetic head slider.

FIG. 20A is a sectional enlarged view of a magnetic head unit.

FIG. 20B is an enlarged view of the magnetic head unit viewed from an air bearing surface.

FIG. 20C is an enlarged view of the magnetic head unit viewed from the air bearing surface.

FIG. 20D is a diagram showing a gap field distribution.

FIG. 20E is a diagram showing a gap field distribution.

FIG. 20F is a diagram showing a gap field distribution.

FIG. 20G is a graph showing a magnetization switching characteristic that takes into account the gap field distributions.

FIG. 21A is an enlarged view of the magnetic head unit.

FIG. 21B is a diagram showing an example in which function division in the reference layer is formed.

FIG. 22 is an enlarged view of the magnetic head unit.

FIG. 23A is a diagram showing the principle of assisted switching by a horizontal field.

FIG. 23B is a diagram showing an effect of the assisted switching by the horizontal field.

FIGS. 24A and 24B are overall diagrams of a magnetic disk device.

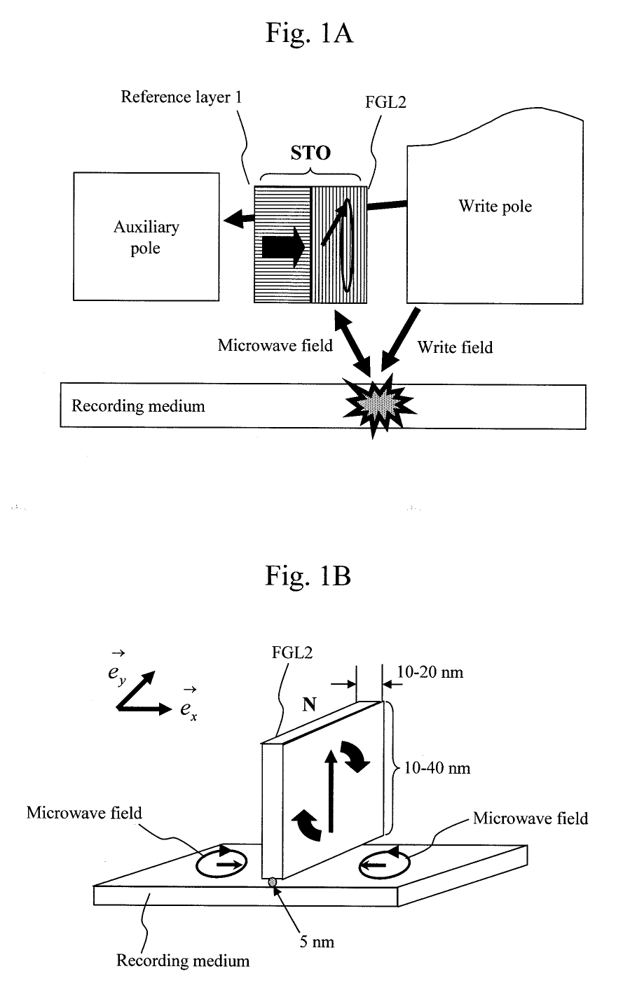

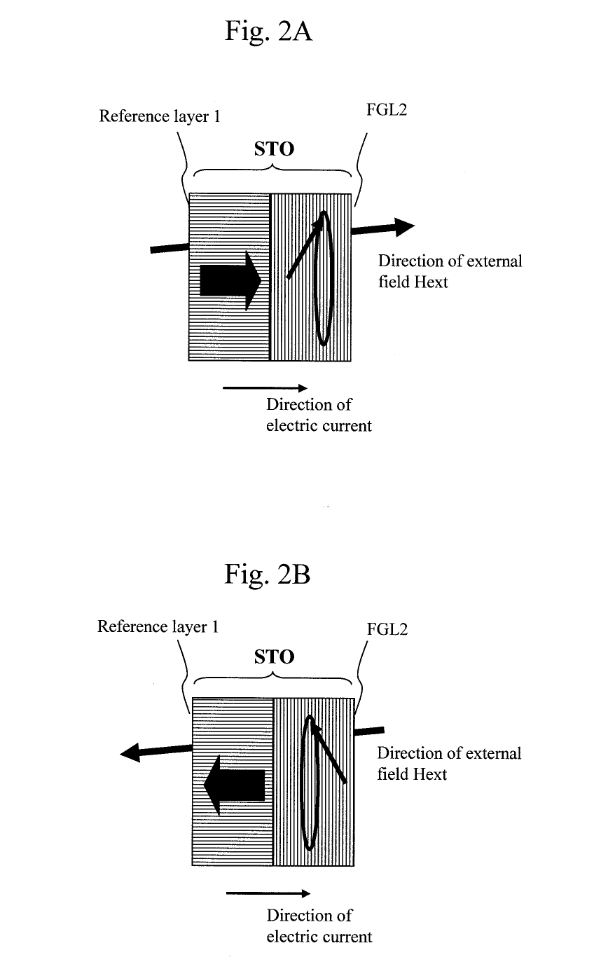

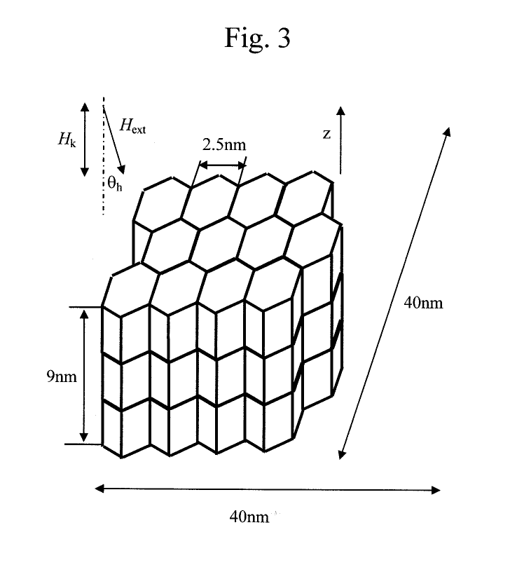

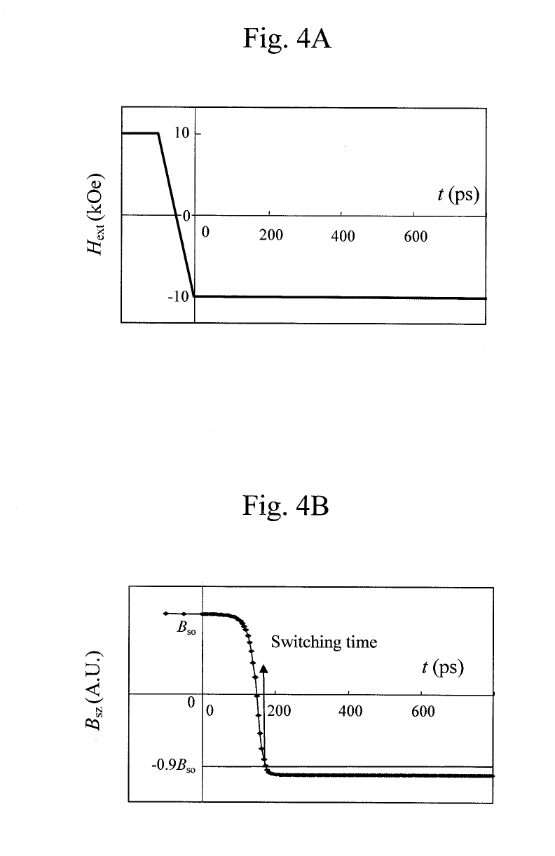

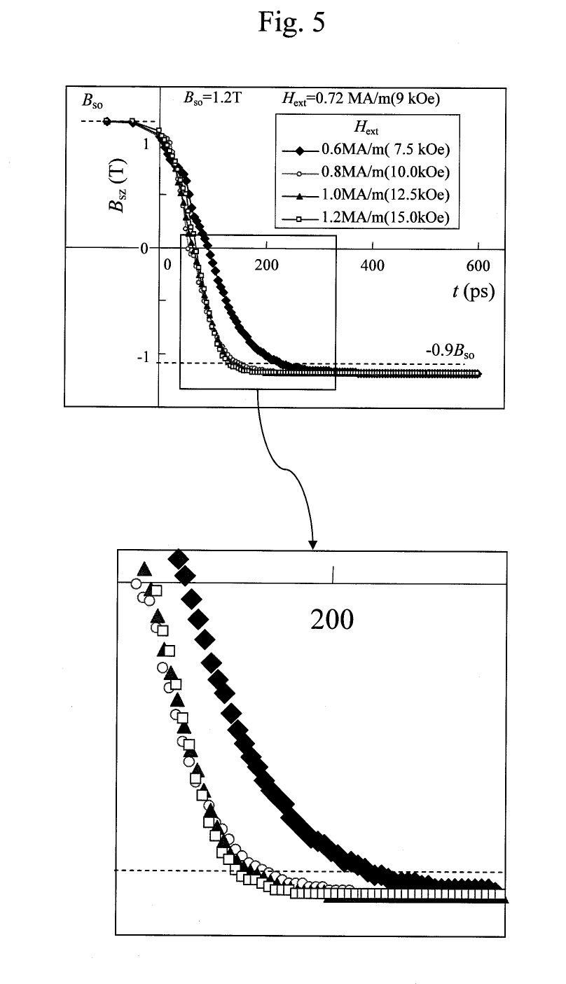

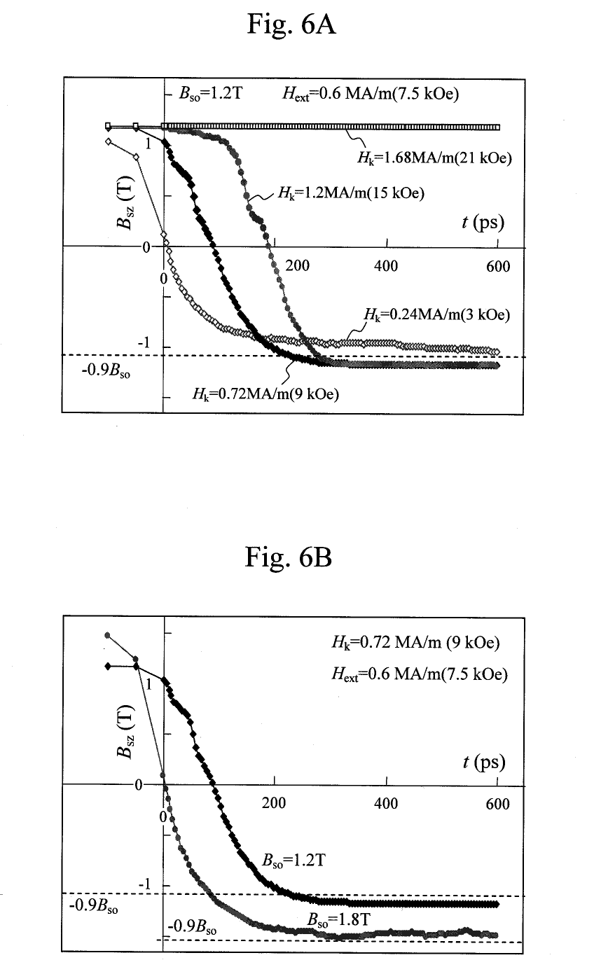

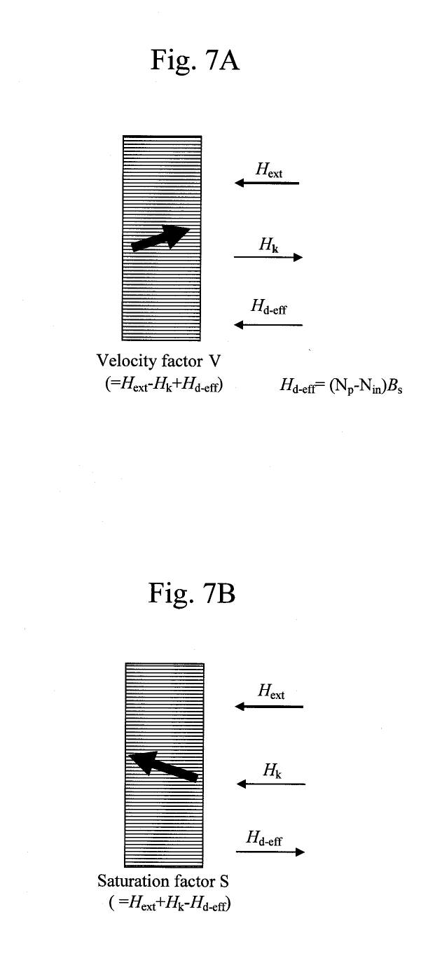

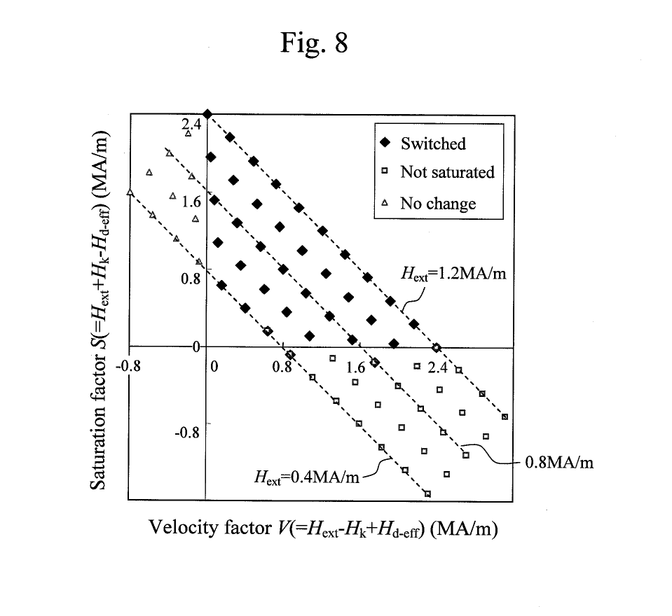

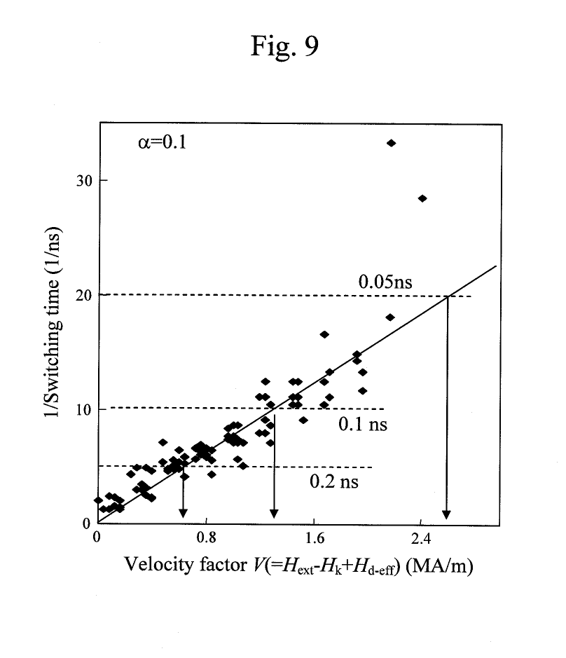

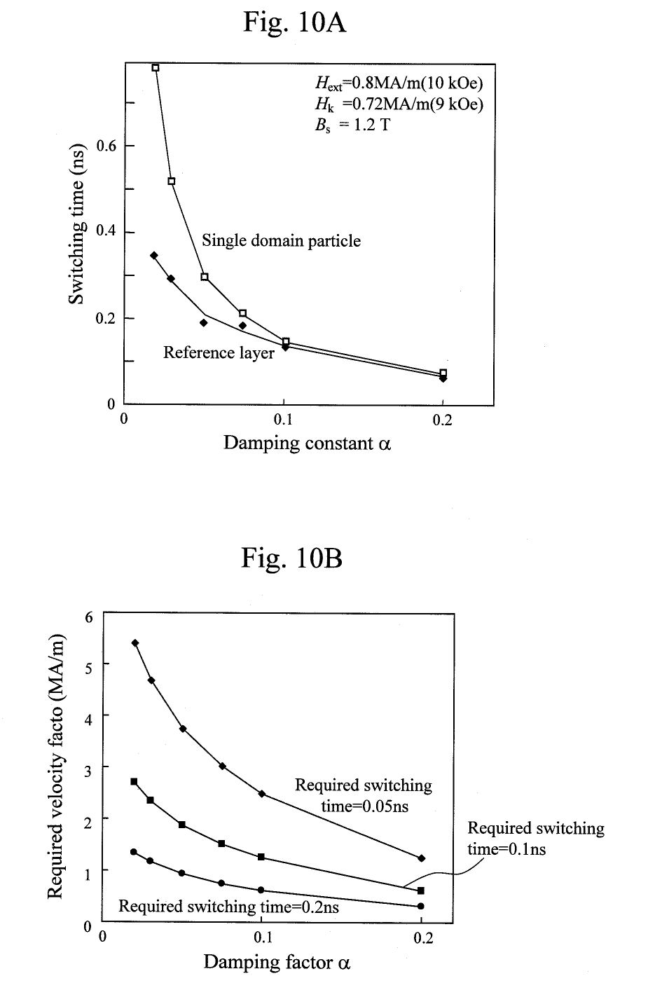

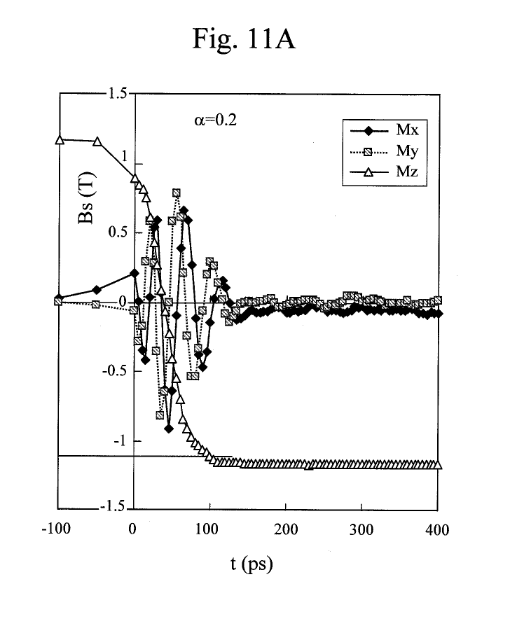

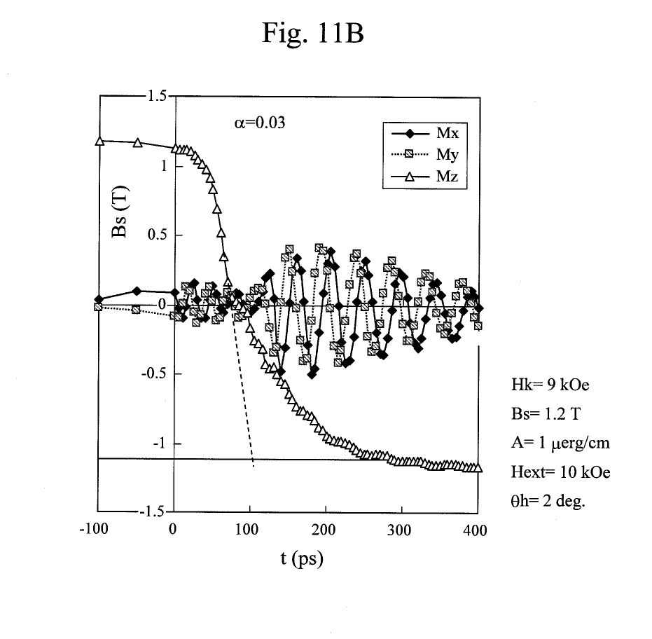

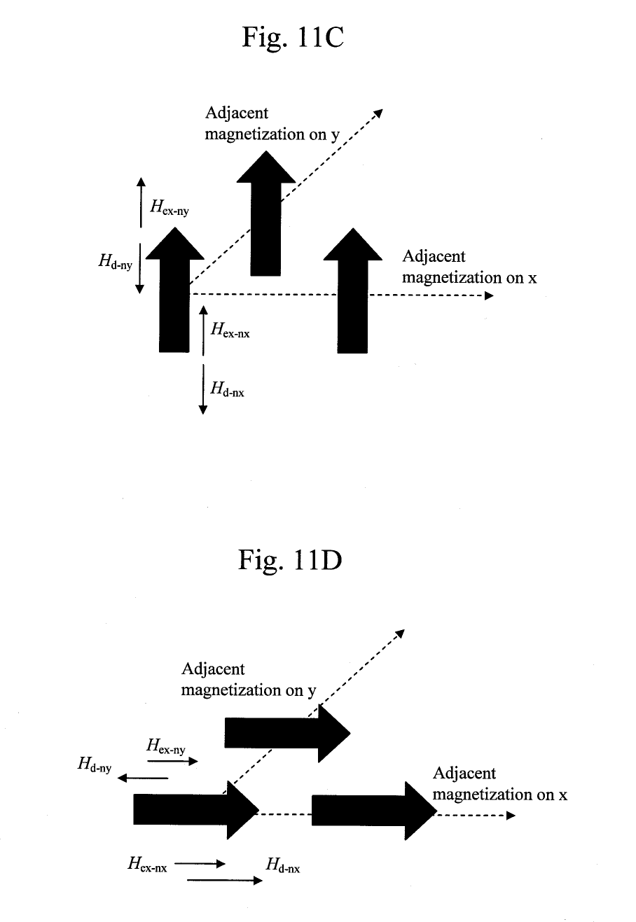

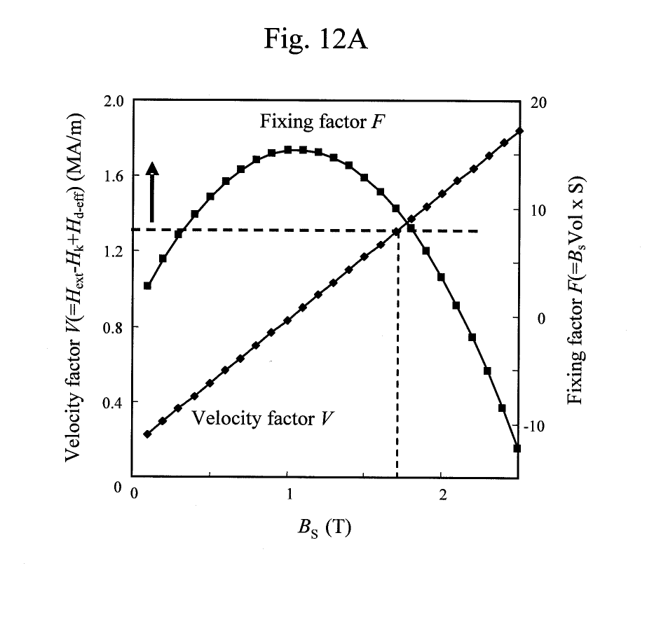

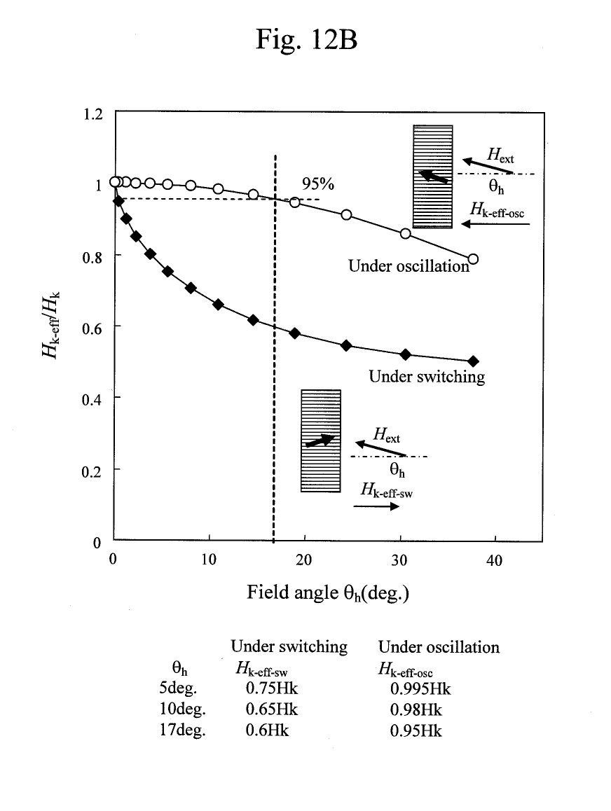

### DETAILED DESCRIPTION OF THE PREFERRED EMBODIMENTS

### First Embodiment

A specific embodiment of the present invention is explained in detail below with reference to the drawings.

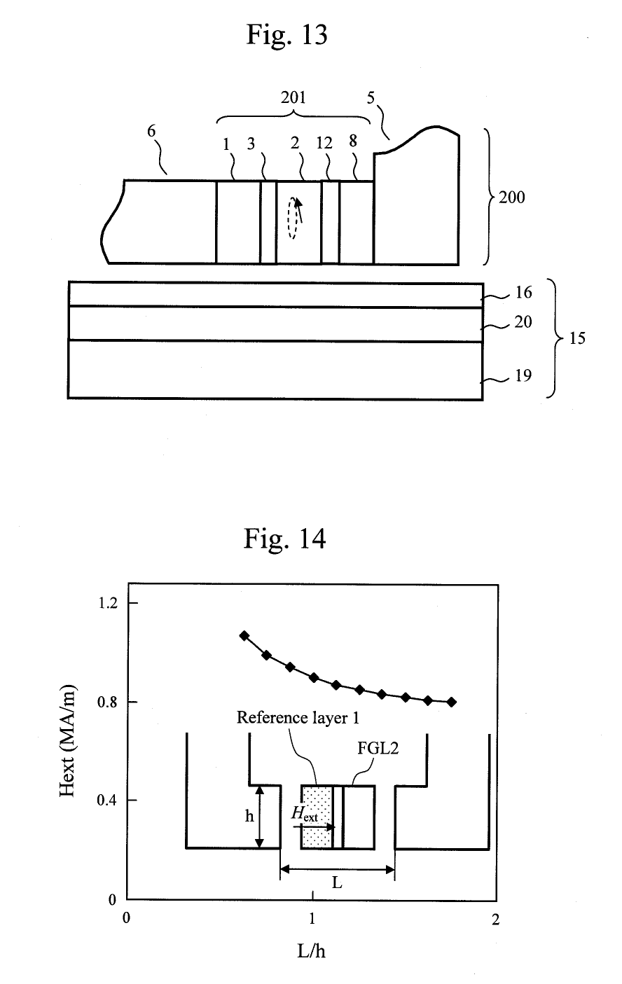

FIG. 13 shows a sectional structure around a recording mechanism of a recording head and a recording medium taken along a surface perpendicular to the surface of the recording medium (an up down direction in the figure) and parallel to a head running direction (a track direction, which is a left or right direction in the figure). In a recording head 200, a magnetic circuit is configured in an upper part of the figure between a write pole 5 and a faced pole 6. However, it is assumed that the magnetic circuit is generally electrically insulated in the upper part of the figure. In the magnetic circuit, a magnetic line of force forms a closed path. The magnetic circuit does not need to be formed only by a magnet. An auxiliary pole or the like may be arranged on the opposite side of the write pole 5 with respect to the faced pole 6 to form a magnetic circuit. In this case, the write pole 5 and the auxiliary pole do not need to be electrically insulated. Further, the recording head 200 includes a coil, a copper wire, and the like for exciting these magnetic circuits. The write pole 5 and the auxiliary pole include electrodes or means for electrically coming into contact with the electrodes and are configured such that an STO driving current from the write pole 5 side to the faced pole 6 side or from the faced pole 6 to the write pole 5 can be fed through an FGL 2. The material of the write pole 5 and the faced pole 6 was a CoFe alloy that had large saturation magnetic flux density and hardly had magneto crystalline anisotropy. In the recording medium 15, on a substrate 19, a laminated film in which a 10 nm-Ru layer was formed on 30 nm-CoFe was used as a base layer 20. A 10 nm-CoCrPt—SiOx layer, a magnetic anisotropy field of which was 2.4 MA/m (30 kOe), was used as a recording layer 16.

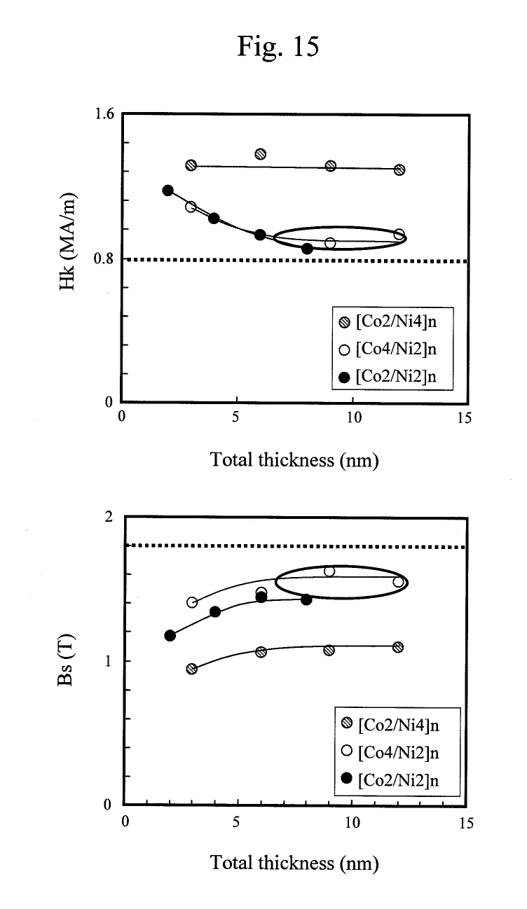

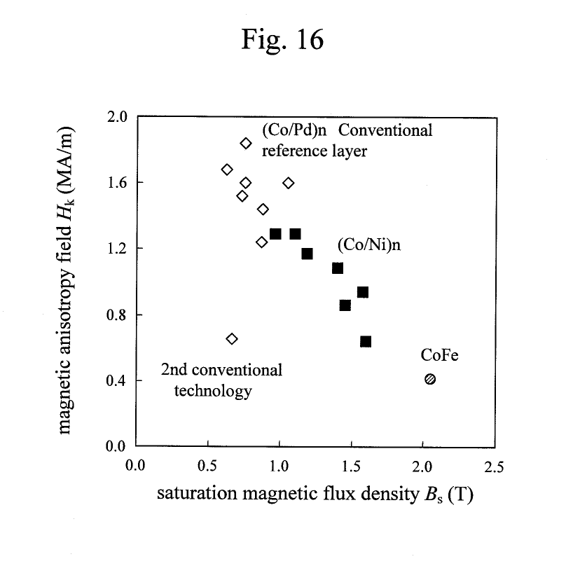

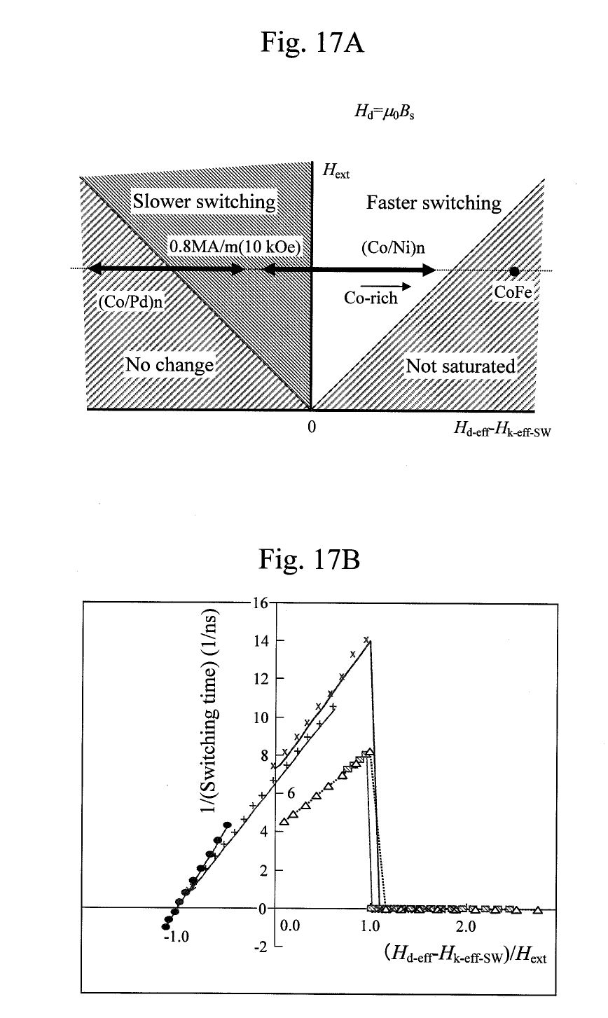

A magnetic flux rectifying layer 8, a nonmagnetic spin scatterer 12, an FGL (a magnetization high-speed rotator) 2, a nonmagnetic spin conductive layer 3, and a reference layer 1 are formed in a layered shape adjacent to the write pole 5 to reach the faced pole 6. The layers from the magnetic flux rectifying layer 8 to the reference layer 1 are formed in a columnar structure extending in a left right direction in the figure. The cross-section of the layers is formed in a rectangular shape long in a direction along an air bearing surface. By forming the layers in the rectangular shape, since shape anisotropy occurs in a track width direction, it is possible to smoothly perform horizontal magnetization rotation of the FGL 2 even if a horizontal component of the FGL 2 of a leakage field from the write pole 5 is present. The write pole 5 and the FGL 2 can be provided close to each other. Length w of a side along the air bearing surface of the rectangular shape is an important factor for determining recording track width. In this embodiment, the length w is set to 35 nm. In microwave assisted magnetic recording, a recording medium having large magnetic anisotropy is used in which recording cannot be performed unless a recording field from the write pole 5 and a high-frequency field from the FGL 2 are aligned. Therefore, the width and the thickness (the length in the head running direction) of the write pole 5 can be set rather large such that a large recording field can be secured. In this embodiment, a recording field of about 0.9 MA/m is obtained by setting the width to 80 nm and setting the thickness to 100 nm. A material having saturation magnetic flux density same as or larger than that of the write pole 5 was used for the magnetic flux rectifying layer 8. Thickness design for the magnetic flux rectifying layer 8 was performed using 3D field analysis software such that a magnetic field from the write pole 5 was perpendicular to a layer direction of the FGL 2 as much as possible. The thickness of the magnetic flux rectifying layer 8 in this embodiment was 10 nm. However, this value depends on the shape of the rectangular shape, a distance to the faced pole and a state of the faced pole, a state of a medium in use, and a state of the magnetic circuit in the upper part of the drawing. The FGL 2 was a CoFe alloy with thickness of 15 nm having large saturation magnetic flux density and hardly having magneto crystalline anisotropy. In the FGL 2, magnetization rotates at high velocity in a plane along the layer and a leakage field from a pole appearing on the air bearing surface and a side acts as a high-frequency field. A material with large saturation magnetic flux density having negative vertical magnetic anisotropy such as a (Co/Fe)n multilayer film may be used for the FGL 2. In this case, horizontal rotation of FGL magnetization is stabilized and a high-frequency field having a higher frequency is obtained. Magnetization rotation driving force of the FGL 2 is a spin torque by spin reflected by the reference layer 1 via the nonmagnetic spin conductive layer 3. It is advisable to cause the spin torque to act to mainly cancel, in the FGL 2, the influence of a gap field that is a sum of magnetic fields generated from the write pole 5, the magnetic flux rectifying layer 8, and the faced pole 6. To obtain the action of this spin torque, it is necessary to feed an STO driving (DC) current from the faced pole 6 side to the write pole 5 side. When a magnetic flux flows in from the write pole 5 side, a rotating direction of magnetization of the FGL 2 is counterclockwise viewed from an upstream side of the STO driving (DC) current. A circularly polarized field in a direction same as a precession direction of magnetization of the recording medium switched by a magnetic field from the write pole 5 can be applied. When a magnetic field flows into the write pole 5, the rotating direction of the magnetization of the FGL 2 is clockwise viewed from the upstream side of the oscillator drive (DC) current. A circularly polarized field in a direction same as a precession direction of magnetization of the recording medium switched by a magnetic field to the write pole 5 can be applied. Therefore, a circularly polarized high-frequency field generated from the FGL 2 has an effect of assisting magnetization switching by the write pole 5 without depending on the polarity of the write pole 5. The effect is not obtained by the high-frequency field generator of the conventional technology 1 in which the direction of spin torque does not change depending on the polarity of the write pole 5. The spin torque action increases as the STO driving current (an electron flow) increases. The spin torque action also increases when about 1 nm of a CoFeB layer having large polarizability is inserted between the nonmagnetic spin conductive layer 3 and the layer adjacent thereto. 2 nm-Cu was used for the nonmagnetic spin conductive layer 3. 3 nm-Ru was used for the nonmagnetic spin scatterer 12. The same action is obtained when Pd or Pt is used. A 12 nm-(Co/Ni)ₙ multilayer film was used for the reference layer 1. Since the length from an end face of the magnetic flux rectifying layer 8 to an end face of the faced pole 6 was set to 40 nm and the height of the FGL 2 was set to 32 nm, a magnetic field applied to the reference layer was about 0.8 MA/m (10 kOe) when analyzed using the 3D field analysis software (FIG. 14). A magnetic characteristic of a trial production (Co/Ni)ₙ multilayer film is shown in FIG. 15. In FIG. 15, [Co2/Ni4]ₙ means n-times lamination of 0.2 nm Co and 0.4 nm Ni. Magnetic characteristics of a (Co/Pd)ₙ multilayer film and a Co film used for comparison are shown in FIG. 16. When magnetization switching characteristics were calculated assuming an external field of 0.8 MA/m (10 kOe) by a computer simulation again using these magnetic parameters, it was predicted that satisfactory fast magnetization switching was obtained in (Co/Ni)ₙ, in particular, when a Co composition was the same as or larger than a Ni composition, i.e., when a total thickness of a Co layer was equal to or larger than a total thickness of a Ni layer (FIG. 17A). The figure is a graph obtained by plotting Hₑₓₜ on the ordinate and plotting H_{d-eff}−Hₖ on the abscissa and predicting magnetization switching characteristics in regions from a calculation result. In the past, since an effect of an external field is not taken into account, it is considered that Hₖ>H_{d-eff} was adopted as a requirement for the reference layer. In this case, since only a substance present in a second quadrant of FIG. 17B is a target, multilayer films such as (Co/Pd)n and (Co/Pt)n were named as candidates of the reference layer. However, in the second quadrant, the large velocity factor V (=Hₑₓₜ+H_{d-eff}−Hₖ) exceeding Hₑₓₜ is not obtained. Therefore, in the present invention, by paying attention to a Hₖ<H_{d-eff} region (a first quadrant) and keeping the saturation factor S (=Hₑₓₜ−H_{d-eff}+Hₖ) and the fixing factor F (=BₛVₒₗ×X) in mind, the inventor succeeded in realizing magnetization switching that is stable during oscillation and is faster. Since the (Co/Ni)ₙ multilayer film can control Bₛ in a wide range of 1.0 to 1.7 T while keeping large magnetic anisotropy energy, it is possible to increase the velocity factor V while securing the required fixing factor F. Therefore, the (Co/Ni)ₙ multilayer film is prospective as a reference layer material used for the STO for MAMR. In particular, when the Co composition is equal to or larger than the Ni composition, since Bₛ exceeds 1.5 T, this is desirable for faster switching. FIG. 17B is a graph obtained by plotting an inverse of a magnetization switching time for (H_{d-eff}−H_{k-eff-sw})/Hₑₓₜ by changing the thicknesses of various reference layer candidate magnetic films. When the thicknesses of the reference layers are reduced, H_{d-eff} increases to 4 πMs and the velocity factor V increases. Therefore, the figure is a curve upward to the right with respect to the respective reference layer candidate magnetic films. This means that (H_{d-eff}−H_{k-eff-sw})/Hₑₓₜ is larger and magnetization switching is faster as a magnetic film is thinner. Black circles indicate a curve with respect to the (Co/Pd)n multilayer film, which is a candidate in the past, and Hₖ>H_{d-eff}. Therefore, the curve does not reach the first quadrant of the figure and the magnetization switching does not become fast. Triangles and squares indicate curves with respect to the (Co/Ni)n multilayer film. It is possible to make the magnetization switching fast until H_{d-eff H}_{k-eff-sw} becomes equal to Hₑₓₜ and switching changes to unsaturated switching. × and + indicate curves formed when the external field is tilted 10 degrees with respect to the (Co/Ni)n multilayer film Faster magnetization switching is obtained compared with magnetization switching obtained when the external field is not tilted.

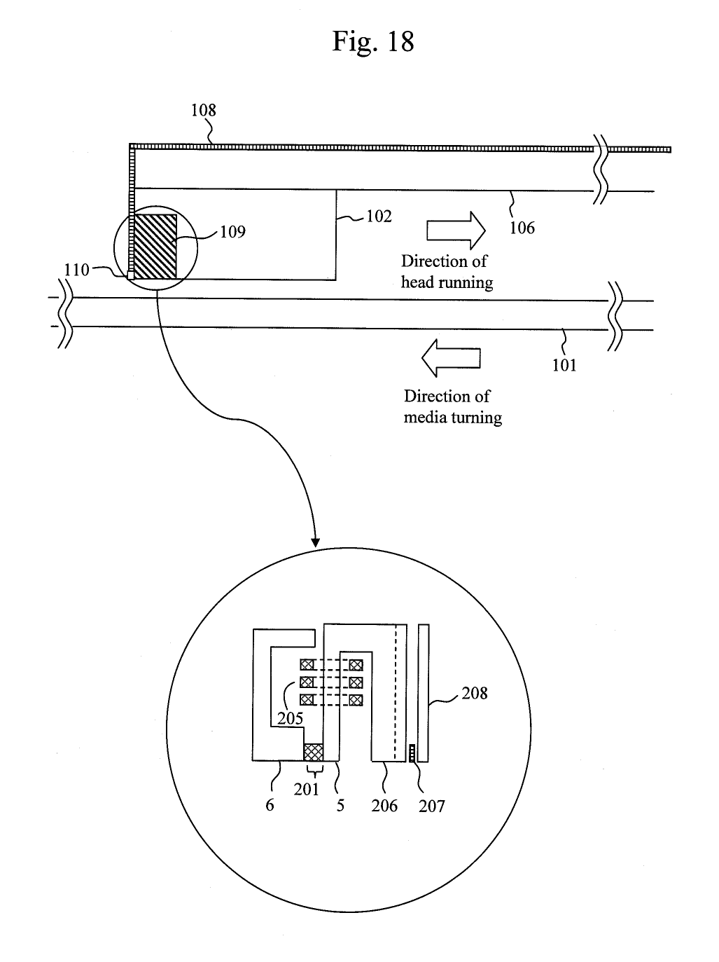

A slider 102 mounted with a recording and reproducing unit 109 incorporating a high-frequency field generation source 201 according to the present invention was attached to a suspension 106 (FIG. 18) and recording and reproducing characteristics were checked using a spin stand. Magnetic recording was performed with head medium relative speed set to 20 m/s, magnetic spacing set to 7 nm, and a track pitch set to 40 nm. The recording was reproduced by a GMR head having a shield interval of 15 nm. When an oscillator drive current was changed and a signal of 800 kFCI was recorded at 315 MHz, a maximum signal to noise ratio of 13.1 dB was obtained. When a signal of 1600 kFCI was recorded at 630 MHz, a signal to noise ratio was 8.0 dB at the maximum. Consequently, it was found that it was possible to realize information transfer speed exceeding 1.2 Gbit/s at recording density exceeding 1 T bits per one square inch. A frequency of a high-frequency field was 35 GHz.

On the other hand, when (Co/Pd)n was used for the reference layer, a maximum signal to noise ratio of 13.0 dB was obtained when a signal of 800 kFCI was recorded at 315 MHz. However, when a signal of 1600 kFCI was recorded at 630 MHz, a signal to noise ratio was substantially deteriorated to 2.0 dB at the maximum. An electric current required for obtaining a high-frequency field of 35 GHz, with which maximum performance was obtained, was about 1.3 times as large as an electric current required when the (Co/Ni)ₙ multilayer film was used for the reference layer. When (Co/Pd)n is used, since Hₖ is large and Bₛ is small, it is considered that velocity factor V (=Hₑₓₜ+H_{d-eff}−Hₖ) decreases and a fast switching characteristic is not obtained. Since (Co/Pd)ₙ had a large damping constant compared with (Co/Ni)ₙ, it was necessary to supplement a spin consumption by spin pumping.

When a CoFe alloy was used for the reference layer, it was found that, when a signal of 1600 kFCI was recorded at 630 MHz, a maximum signal to noise ratio was not so bad at 7.0 dB but, when a signal of 800 kFCI was recorded at 315 MHz, a maximum signal to noise ratio was 11.0 dB and a sufficient error rate was not obtained. Since the CoFe alloy has large saturation magnetic flux density, the saturator factor S (=Hₑₓₜ−H_{d-eff}+Hₖ) is negative and is not saturated. Therefore, it is considered that reference layer magnetization fluctuates and stable spin torque is not supplied to the FGL.

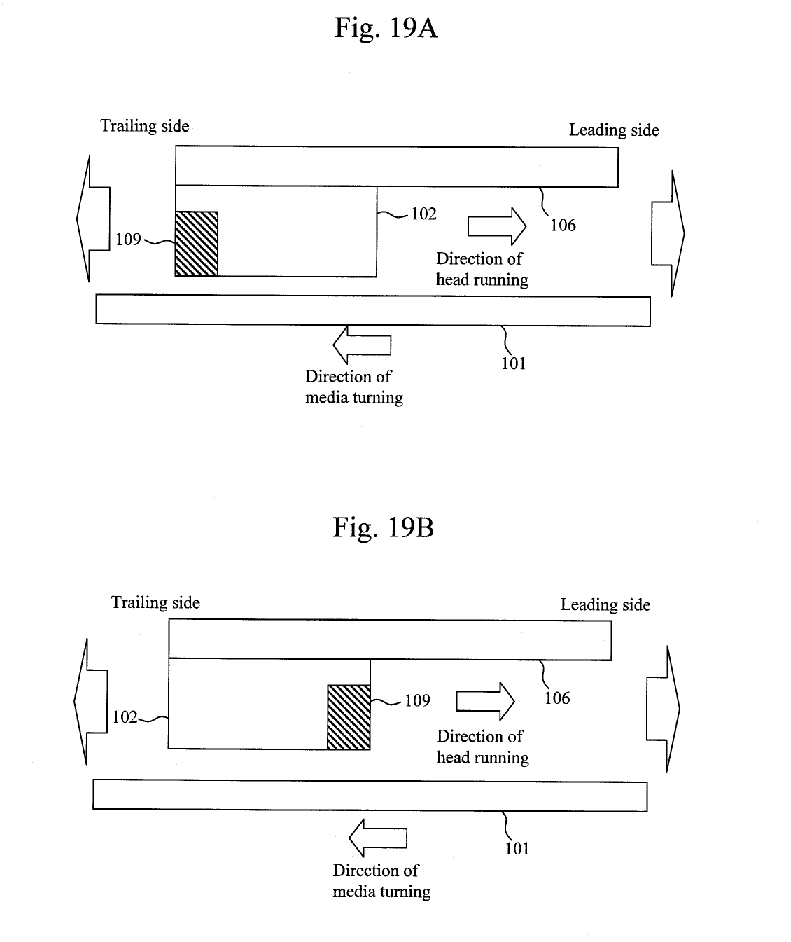

An arrangement relation between a magnetic head running direction and a recording medium is explained with reference to FIGS. 19A and 19B. There are two types as a form of placing a magnetic head on a magnetic head slider. One is arrangement on a trailing side shown in FIG. 19A. The other is arrangement on a leading side shown in FIG. 19B. The trailing side and the leading side depend on a relative moving direction of the magnetic head slider with respect to the recording medium. If a turning direction of the recording medium is opposite to a direction shown in FIG. 19A or 19B (a direction of an arrow in the figure), arrangement on the leading side is shown in FIG. 19A and arrangement on the trailing side is shown in FIG. 19B. In principle, if the polarity of a spindle motor is reversed to turn the recording medium in the opposite direction, it is possible to reverse the relation between the trailing side and the leading side. However, since it is necessary to accurately control the number of turns, it is unrealistic to change the polarity of the spindle motor. When a head for microwave assisted magnetic recording was used in which (Co/Ni)n was used for the reference layer of the present invention, irrespective of which arrangement shown in FIG. 19A or 19B was used, a signal to noise ratio and an overwrite characteristic sufficient for recording and reproduction at recording density exceeding 1 T bits per one square inch were obtained.

### Second Embodiment

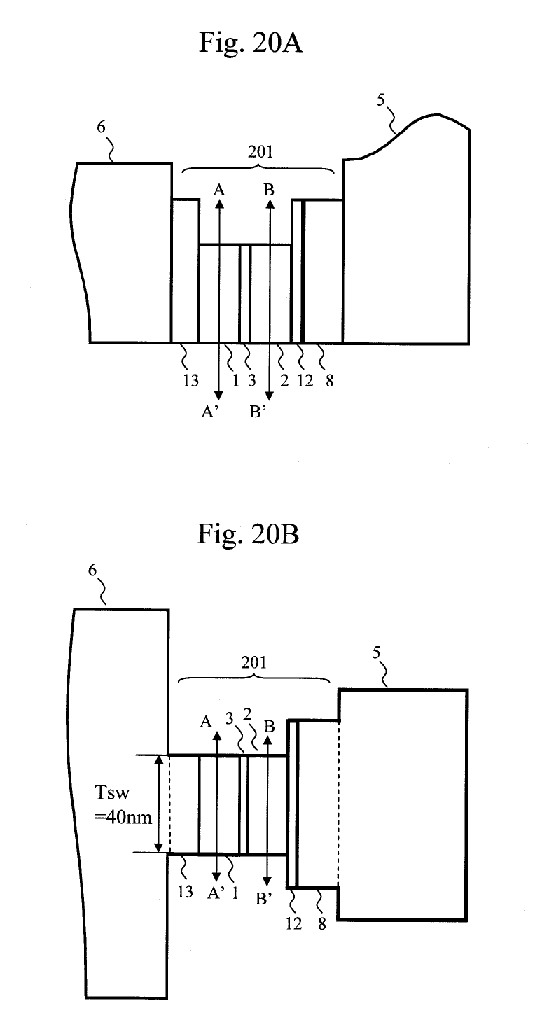

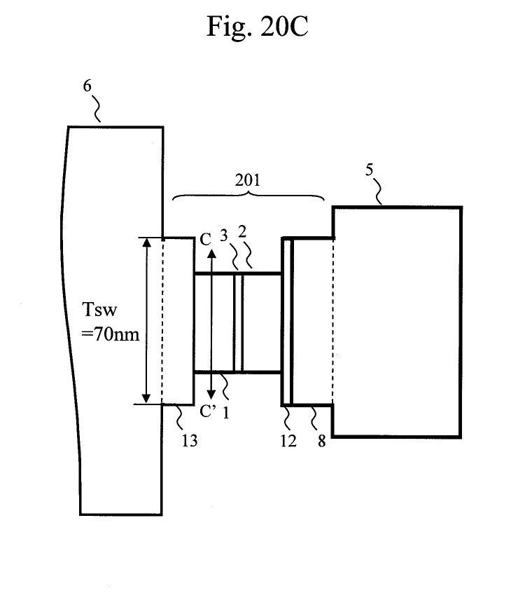

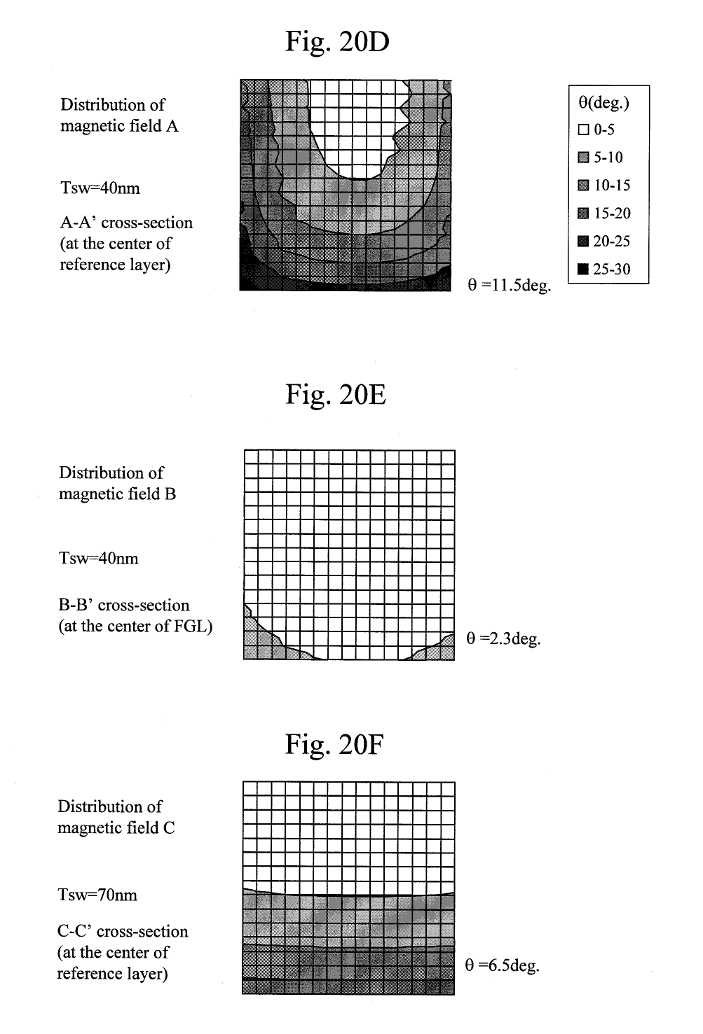

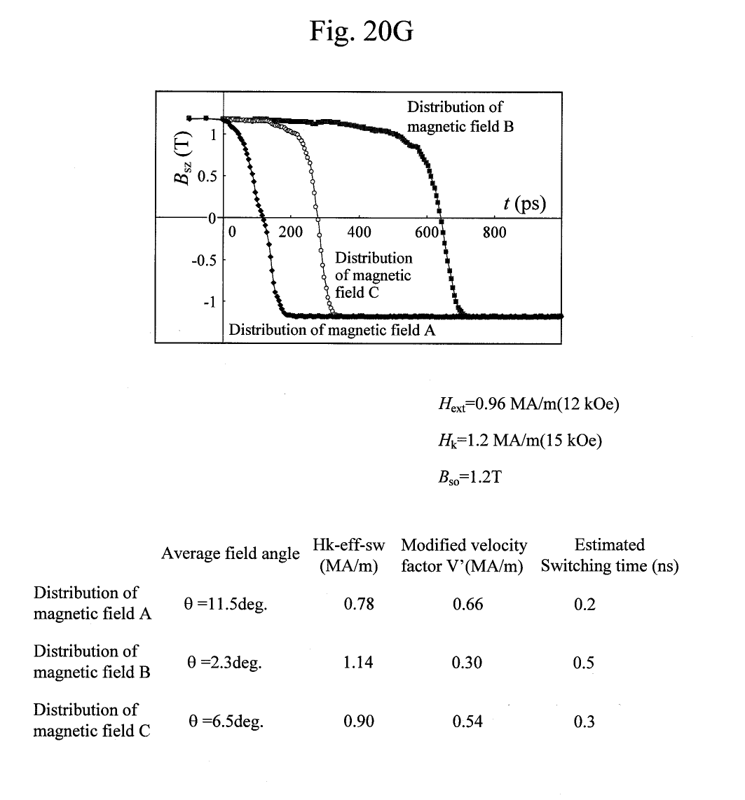

FIGS. 20A and 20B are diagrams showing a second configuration example of the recording head and the recording medium according to the present invention. FIG. 20A shows a sectional structure around a recording mechanism of the recording head taken along a surface perpendicular to the surface of the recording medium (an up down direction in the figure) and parallel to a head running direction (a track direction, which is a left or right direction in the figure). As in the first embodiment, magnetic circuits are configured in an upper part of the figure between the write pole 5 and the faced pole 6, the magnetic circuits are generally electrically insulated in the upper part of the figure, the recording head includes a coil, a copper wire, and the like for exciting these magnetic circuits, the write pole 5 and the faced pole 6 include electrodes or means for electrically coming into contact with the electrodes and are configured such that an STO driving current can be fed through the FGL 2. The material of the write pole 5 and the faced pole 6 was a CoFe alloy that had large saturation magnetic flux density and hardly had magneto crystalline anisotropy. In the recording medium 15, on the substrate 19, a laminated film in which a 10 nm-Ru layer was formed on 30 nm-CoFe was used as the base layer 20. A 10 nm-FePt pattern layer, a magnetic anisotropy field of which was 2.4 MA/m (30 kOe), was used as the recording layer 16.

The magnetic flux rectifying layer 8, the nonmagnetic spin scatterer 12, the FGL (a magnetization high-speed rotator) 2, the nonmagnetic spin conductive layer 3, the reference layer 1, and a second magnetic flux rectifying layer 13 are formed in a layered shape adjacent to the write pole 5 to reach the faced pole 6. The layers from the FGL 2 to the reference layer 1 are formed in a columnar structure extending in a left right direction in the figure. The cross-section of the layers is formed in a rectangular shape long in a direction along an air bearing surface. The length w of a side along the air bearing surface of the rectangular shape is an important factor for determining recording track width. In this embodiment, the length w was set to 40 nm. In microwave assisted magnetic recording, a recording medium having large magnetic anisotropy is used in which recording cannot be performed unless a recording field from the write pole 5 and a high-frequency field from the FGL 2 are aligned. Therefore, the width and the thickness (the length in the head running direction) of the write pole 5 can be set rather large such that a large recording field can be secured. In this embodiment, a recording field of about 0.9 MA/m is obtained by setting the width to 80 nm and setting the thickness to 100 nm. A material having saturation magnetic flux density same as or larger than that of the write pole 5 was used for the magnetic flux rectifying layer 8. Thickness design for the magnetic flux rectifying layer 8 was performed using 3D field analysis software such that a magnetic field from the write pole 5 is perpendicular to a layer direction of the FGL 2 as much as possible. The thickness of the magnetic flux rectifying layer 8 in this embodiment was 10 nm. However, this value depends on the shape of the rectangular shape, a distance to the faced pole and a state of the faced pole, a state of a medium in use, and a state of the magnetic circuit in the upper part of the drawing. The FGL 2 is a (Co/Fe)n multilayer film with thickness of 15 nm having large saturation magnetic flux density and hardly having magneto crystalline anisotropy in the surface of the layer (having negative vertical magnetic anisotropy). In the FGL 2, magnetization rotates at high velocity in a plane along the layer and a leakage field from a pole appearing on the air bearing surface and a side acts as a high-frequency field. Magnetization rotation driving force of the FGL 2 is spin torque by spin reflected by the reference layer 1 via the nonmagnetic spin conductive layer 3. It is advisable to cause the spin torque to act to mainly cancel, in the FGL 2, the influence of a gap field that is a sum of magnetic fields generated from the write pole 5, the magnetic flux rectifying layer 8, and the faced pole 6. To obtain the action of this spin torque, it is necessary to feed an STO driving (DC) current from the faced pole 6 side to the write pole 5 side. When a magnetic flux flows in from the write pole 5 side, a rotating direction of magnetization of the FGL 2 is counterclockwise viewed from an upstream side of the STO driving (DC) current. A circularly polarized field in a direction same as a precession direction of magnetization of the recording medium switched by a magnetic field from the write pole 5 can be applied. When a magnetic field flows into the write pole 5, the rotating direction of the magnetization of the FGL 2 is clockwise viewed from the upstream side of the oscillator drive (DC) current. A circularly polarized field in a direction same as a precession direction of magnetization of the recording medium switched by a magnetic field to the write pole 5 can be applied. Therefore, a circularly polarized high-frequency field generated from the FGL 2 has an effect of assisting magnetization switching by the write pole 5 without depending on the polarity of the write pole 5. 2 nm-Cu was used for the nonmagnetic spin conductive layer 3. 3 nm-Pt was used for the nonmagnetic spin scatterer 12. A 12 nm-(Co/Ni)ₙ multilayer film was used for the reference layer 1. Since the length from an end face of the magnetic flux rectifying layer 8 to an end face of the second magnetic flux rectifying layer 13 was set to 40 nm and the height of the FGL 2 was set to 38 nm, a magnetic field applied to the reference layer was about 0.8 MA/m (10 kOe) when analyzed using the 3D field analysis software.

The recording head according to this embodiment is configured such that a magnetic field applied to the reference layer 1 is set at an angle tilting from the direction perpendicular to the surface of the reference layer 1. FIG. 20B is a diagram of the recording head shown in FIG. 20A viewed from the air bearing surface. The width of the second magnetic flux rectifying layer 13 is narrow compared with the width in a cross track direction of the magnetic flux rectifying layer 8. Results obtained by calculating magnetic field distributions (angles of magnetic fields) of a cross-section A-A′ and a cross-section B-B′ using the 3D field analysis software are respectively shown in FIGS. 20D and 20E. FIG. 20F is a diagram of a magnetic field distribution in a cross-section C-C′ calculated for comparison when the width of the magnetic flux rectifying layer 8 and the width of the second magnetic flux rectifying layer 13 are equal (FIG. 20F). In the cross-section A-A′, a magnetic field distribution near the narrowed second magnetic field rectifying layer 13 is observed. The magnetic field distribution tilts at 30 degrees at the maximum and 11.5 degrees in average. It is expected that the magnetic field distortion is effective for an increase in velocity of magnetization switching of the reference layer 1. In the cross-section B-B′, a magnetic field distribution in a position away from the narrowed second magnetic flux rectifying layer 13 is observed. The magnetic field tilts at 10 degrees at the maximum and 2.3 degrees in average. Since a horizontal direction component of the magnetic field is small, the magnetic field distribution is considered to be suitable for a setting place of the FGL 2. In the cross-section C-C′, a magnetic field distribution near the second magnetic flux rectifying layer 13 obtained when the width of the magnetic flux rectifying layer 8 and the width of the second magnetic flux rectifying layer 13 are equal is observed. The magnetic field tilts at 10 degrees at the maximum and 2.3 degrees in average. A magnetic field distribution tilting at 25 degrees at the maximum and 6.5 degrees in average is considered to be insufficient for an increase in velocity of magnetization switching of the reference layer 1. FIG. 20G shows a state of magnetization switching that occurs when a magnet with Hₖ=1.2 MA/m (15 kOe) and Bₛ=1.2 T is placed in the respective magnetic field distributions. The maximum size of a magnetic field in the respective magnetic field distribution is set to 0.96 MA/m (12 kOe). Obtained times of magnetization switching respectively substantially coincide with switching times estimated using the velocity factor of equation (8). It is surmised that, in the recording head shown in FIG. 20B, the reference layer is desirably set near the narrowed second magnetic flux rectifying layer 13.

The slider 102 mounted with the recording and reproducing unit 109 incorporating the high-frequency field generation source 201 of the recording head shown in FIG. 20B was attached to the suspension 106 (FIG. 18) and recording and reproducing characteristics were checked using a spin stand. Magnetic recording was performed with head medium relative speed set to 20 m/s, magnetic spacing set to 7 nm, and a track pitch set to 50 nm. The recording was reproduced by a GMR head having a shield interval of 14 nm. When an oscillator drive current was changed and a signal of 900 kFCI was recorded at 354 MHz, a maximum signal to noise ratio of 13.0 dB was obtained. When a signal of 1800 kFCI was recorded at 709 MHz, a signal to noise ratio was 8.1 dB at the maximum. Consequently, it was found that it was possible to realize information transfer speed exceeding 1.4 Gbit/s at recording density exceeding 1 T bits per one square inch. A frequency of a high-frequency field at this point was 35 GHz. When the recording head shown in FIG. 20C was used, a maximum signal to noise ratio of 13.2 dB was obtained when a signal of 900 kFCI was recorded at 354 MHz. However, when a signal of 1800 kFCI was recorded at 709 MHz, a signal to noise ratio was substantially deteriorated to 4.0 dB at the maximum.

### Third Embodiment

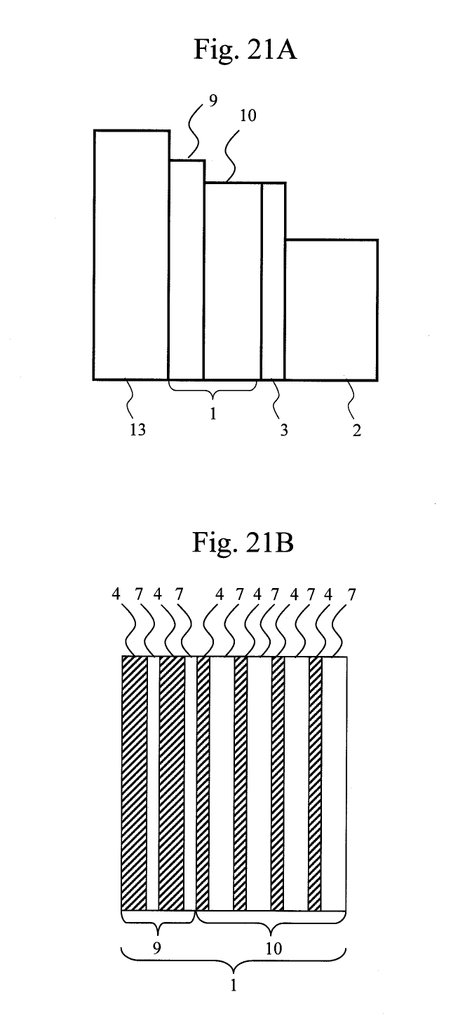

FIGS. 21A and 21B are diagrams showing a third configuration example of the recording head and the recording medium according to the present invention. In a third embodiment, in the recording head according to the second embodiment, the reference layer 1 is divided and portions of the reference layer 1 are optimized according to functions of the portions. As shown in FIG. 21A, a portion (a high magnetic anisotropy region 10) on the FGL 2 side of the reference layer 1 is desirably more firmly fixed in order to supply spin torque to the FGL 2. On the other hand, the second magnetic flux rectifying layer 13 side of the reference layer 1 is a portion (a magnetization switching start region 9) where a magnetic field distribution from the second magnetic flux rectifying layer 13 is large and magnetization switching of the reference layer 1 is started. Therefore, a switching field is desirably low. In the magnetization switching start region 9, Hₖ is desirably low. However, excessively large Bₛ is undesirable because the excessively large Bₛ markedly prevents stability during oscillation of the reference layer 1. If there is a portion of the magnetization switching start region 9 extending beyond the high magnetic anisotropy region 10, the extending portion is not affected by an exchange mutual action from the high magnetic anisotropy region 10. Therefore, the extending portion is desirable because the extending portion serves as a start point of reference layer magnetization switching. The magnetization switching start region 9 and the high magnetic anisotropy region 10 are desirably coupled by moderate exchange mutual action. Further, if the FGL 2 is formed small compared with the high magnetic anisotropy region 10 and the nonmagnetic spin conductive layer 3, this is desirable because 1) spin injected into the FGL 2 from the reference layer 1 increases and an STO driving current decreases and 2) the volume of the reference layer 1 increases and magnetization stability during oscillation increases. When the reference layer 1 is divided and the portions of the reference layer 1 are optimized according to the functions of the portions, it is advisable to estimate a velocity factor and a saturation factor in the magnetization switching start region 9. It is advisable to add up effects from the portions of the reference layer 1 to obtain a fixing factor.

FIG. 21B shows a configuration for obtaining the characteristics explained above in a (Co/Ni)n multilayer film. In the (Co/Ni)n multilayer film, it is possible to control magnetic anisotropy and saturation magnetic flux density according to lamination thickness of Co4 and Ni7. A desired laminated structure is obtained by forming Co4 thick compared with Ni7 in the magnetization switching start region 9 and forming Co4 thin compared with Ni7 in the high magnetic anisotropy region 10. In this structure, the magnetization switching start region 9 and the high magnetic anisotropy region 10 can be continuously formed. Therefore, there is a characteristic that the exchange mutual action in a boundary portion is not deteriorated.

Recording and reproducing characteristics by a spin stand same as that in the second embodiment were checked using the recording head shown in FIGS. 21A and 21B. With head medium relative speed set to 20 m/s, magnetic spacing set to 7 nm, and a track pitch set to 35 nm, magnetic recording was performed while a track was overwritten. The recording was reproduced by a GMR head having a shield interval of 14 nm. When an oscillator drive current was changed and a signal of 980 kFCI was recorded at 385 MHz, a maximum signal to noise ratio of 13.3 dB was obtained. When a signal of 1960 kFCI was recorded at 772 MHz, a signal to noise ratio was 8.2 dB at the maximum. Consequently, it was found that it was possible to realize information transfer speed exceeding 1.5 Gbit/s at recording density exceeding 1.4 T bits per one square inch. An electric current required for generation of a high-frequency field was 80% of that in the second embodiment.

### Fourth Embodiment

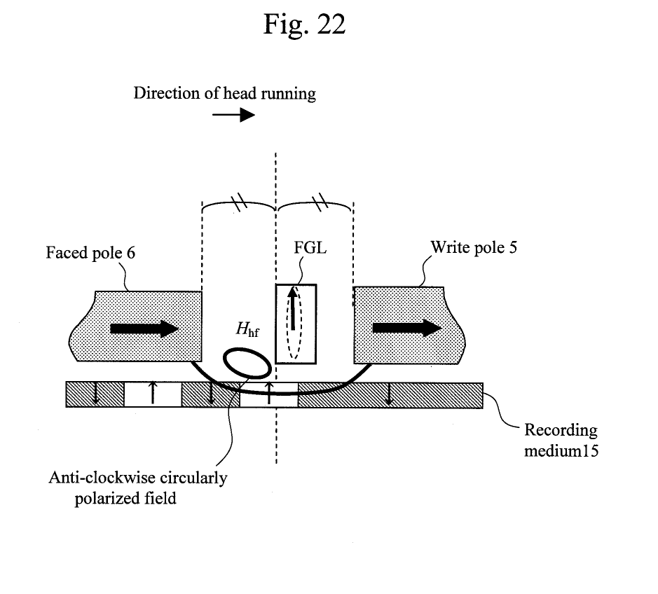

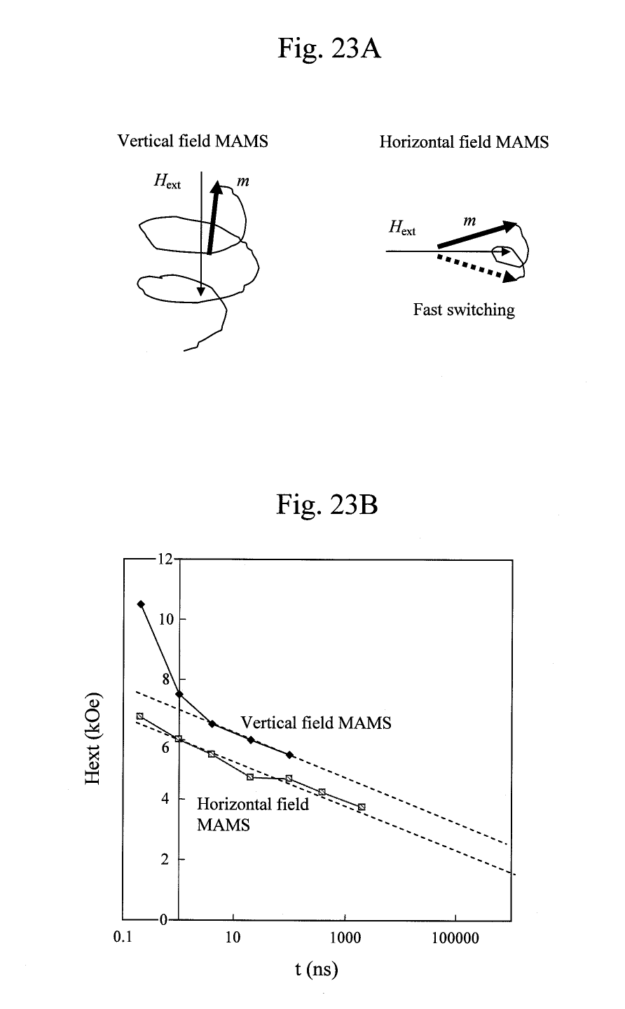

FIG. 22 is a diagram showing a fourth configuration example of the recording head and the recording medium according to the present invention. In a fourth embodiment, assisted recording is performed when a head field becomes substantially parallel to the surface of the recording medium. In the recording medium, a soft under layer is not provided not to attract a magnetic field from the recording head. The principle of this embodiment is shown in FIGS. 23A and 23B. In the vertical field MAMS (Microwave assist magnetic switching) of the conventional technology, since magnetization before switching is in a direction substantially opposite to a recording field, time for precession is required for switching of medium magnetization (FIG. 23A). On the other hand, in the horizontal field MAMS of the present invention, since magnetization is tilted to a switching side in advance, a switching time is hardly required. A result obtained by performing a switching experiment by short-time pulse according to a computer simulation in order to verify the time required for switching is shown in FIG. 23B. In the vertical field MAMS, around time when a pulse time decreases to be shorter than 1 ns, a magnetic field required for switching suddenly increases simultaneously with a reduction in the pulse time. On the other hand, in the horizontal field MAMS, even if the pulse time is 0.2 ns, a sudden increase in the required magnetic field is not observed. Extremely fast magnetization switching is considered to be performed.

A head in which the reference layer structure shown in FIGS. 21A and 21B was incorporated in a horizontal head field application system shown in FIG. 22 was manufactured and recording and reproducing characteristics by a spin stand same as that in the second embodiment were checked. With head medium relative speed set to 20 m/s, magnetic spacing set to 7 nm, and a track pitch set to 30 nm, magnetic recording was performed while a track was overwritten. The recording was reproduced by a GMR head having a shield interval of 12 nm. When an oscillator drive current was changed and a signal of 1250 kFCI was recorded at 493 MHz, a maximum signal to noise ratio of 13.0 dB was obtained. When a signal of 2500 kFCI was recorded at 984 MHz, a signal to noise ratio was 7.9 dB at the maximum. Consequently, it was found that it was possible to realize information transfer speed exceeding 2.0 Gbit/s at recording density exceeding 2.1 T bits per one square inch. A signal of 2500 kFCI was able to be recorded at head medium relative speed of 20 m/s and 1476 MHz by using an STO excitation driver capable of temporarily weakening an STO excitation current in synchronization with switching time of write pole polarity. Information transfer speed of 3.0 Gbit/s was able to be realized.

### Fifth Embodiment

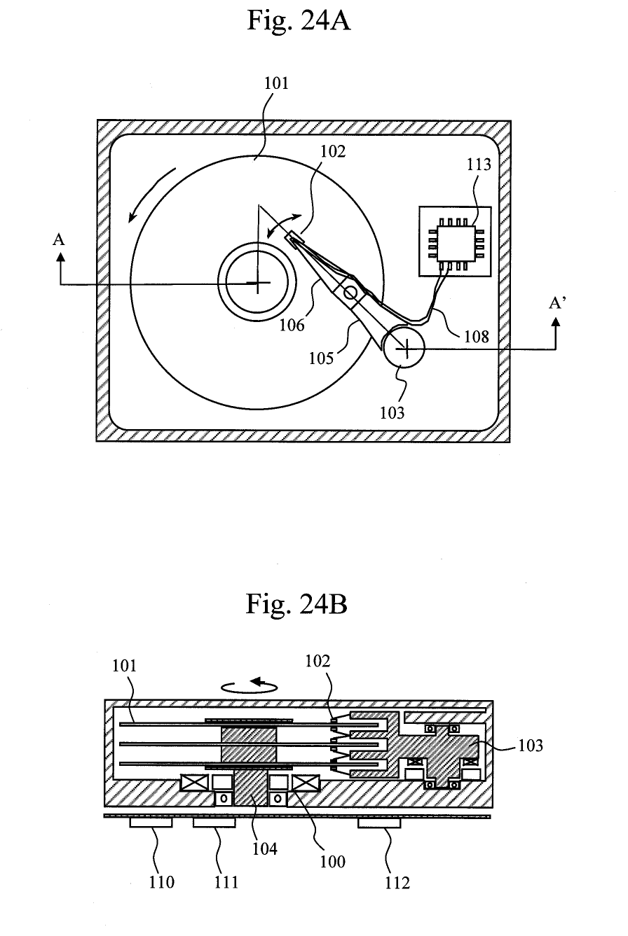

The recording head and the recording medium explained in the first to fourth embodiments of the present invention were incorporated in a magnetic disk device and performance evaluation was performed. FIGS. 24A and 24B are schematic diagrams showing an overall configuration of an information recording device according to a fifth embodiment and are diagrams showing a basic configuration of the magnetic disk device. FIG. 24A is a top view and FIG. 24B is a sectional view taken along A-N in FIG. 24A. A recording medium 101 is fixed to a rotary bearing 104 and rotated by a motor 100. In an example shown in FIGS. 24A and 24B, three 2.5-inch magnetic disks and six magnetic heads are mounted. However, one or more magnetic disks and one or more magnetic heads only have to be mounted. The recording medium 101 is formed in a disc shape and recording layers are formed on both surfaces of the recording medium 101. A slider 102 moves in a substantially radial direction on the surface of the rotating recording medium. The slider 102 has a magnetic head at the distal end thereof. A suspension 106 is supported by a rotary actuator 103 via an arm 105. The suspension 106 includes a function of pressing the slider 102 against the recording medium 101 with a predetermined load and separating the slider 102 from the recording medium 101. An electric current for driving components of the magnetic head is supplied from an IC amplifier 113 via a wire 108. Processing of a recording signal supplied to a recording head unit and a reproduction signal detected from a reproduction head unit is executed by a channel IC 112 for read write shown in FIG. 24B. A control operation for the entire information processing device is realized by a processor 110 executing a computer program for disk control stored in a memory 111. Therefore, in the case of this embodiment, the processor 110 and the memory 111 configure a so-called disk controller.

In the case of a magnetic disk device incorporating the recording head explained in the first to third embodiments and continuous media, an information recording and reproducing device having 1.0 T bits per one square inch, a total recording capacity of 4 T bytes, and information transfer speed of 1.2 Gbit/s was obtained. In the case of a magnetic disk device incorporating the recording head explained in the first to third embodiments and a bit pattern medium, an information recording and reproducing device having 1.5 T bits per one square inch, a total recording capacity of 6 T bytes, and information transfer speed of 1.2 Gbit/s was obtained. In the case of a magnetic disk device incorporating the recording head and the configuration explained in the fourth embodiment and continuous media, an information recording and reproducing device having 2.0 T bits per one square inch, a total recording capacity of 8 T bytes, and information transfer speed of 2.1 Gbit/s was obtained. In the case of a magnetic disk device incorporating the recording head and the configuration explained in the fourth embodiment and a bit pattern medium, an information recording and reproducing device having 3.0 T bits per one square inch, a total recording capacity of 12 T bytes, and information transfer speed of 2.0 Gbit/s was obtained.

### DESCRIPTION OF SYMBOLS

1 reference layer (fixing layer)
2 FGL (Field Generation Layer or magnetization high-speed rotator)
3 nonmagnetic spin conductive layer
4 Co layer
5 write pole
6 faced pole
7 Ni layer
8 magnetic flux rectifying layer
12 nonmagnetic spin scatterer
13 second magnetic flux rectifying layer
15 recording medium
16 recording layer
20 base layer
19 substrate
200 recording head
201 high-frequency field generation source
100 motor
101 recording medium
102 slider
103 rotary actuator
104 rotary bearing
105 arm
106 suspension
108 wire
110 processor
111 memory
112 channel IC
113 IC amplifier

What is claimed is:

1. A magnetic recording head comprising:
a write pole;
a field generation layer that generates a high-frequency field; and
a reference layer that supplies spin torque to the field generation layer, wherein
when an externally applied field to the reference layer is represented as Hₑₓₜ, a magnetic anisotropy field of the reference layer is represented as Hₖ, and an effective demagnetizing field in a vertical direction of a film surface of the reference layer is represented as H_{d-eff}, conditions Hₑₓₜ−Hₖ+H_{d-eff}>0 and Hₑₓₜ+Hₖ−H_{d-eff}>0 are satisfied.

2. The magnetic recording head according to claim 1, wherein the externally applied field is applied while being tilted from a direction perpendicular to the surface of the reference layer.

3. The magnetic recording head according to claim 1, wherein
the magnetic anisotropy field Hₖ is effective magnetic anisotropy field H_{k-eff}, and
conditions Hₑₓₜ−H_{k-eff}+H_{d-eff}>0 and Hₑₓₜ+H_{k-eff}−H_{d-eff}>0 are satisfied.

4. The magnetic recording head according to claim 1, wherein the reference layer includes a columnar granular structure in a laminating direction.

5. The magnetic recording head according to claim 1, wherein, when a damping coefficient of the reference layer is represented as α and a required reference layer magnetization switching time is represented as required t_{sw}, {1−log₂(α/0.1)12}/(8×required t_{sw}) is equal to or larger than 0.7.

6. The magnetic recording head according to claim 1, wherein
a first magnetic flux rectifying layer is provided between the reference layer and the write pole,
a second magnetic flux rectifying layer is provided on an opposite side of the write pole side with respect to the reference layer, and
width in a cross track direction of the second magnetic flux rectifying layer on an air bearing surface is smaller than width in a cross track direction of the first magnetic flux rectifying layer.

7. The magnetic recording head according to claim 1, wherein the reference layer is formed to be divided into a high magnetic anisotropy region and a magnetization switching start region.

8. The magnetic recording head according to claim 7, wherein the magnetization switching start region includes a region extending beyond the high magnetic anisotropy region viewed from a running direction of a head.

9. A magnetic recording head comprising:
a write pole;
a field generation layer that generates a high-frequency field; and
a reference layer including a (Co/Ni) multilayer film that supplies spin torque to the field generation layer.

10. The magnetic recording head according to claim 9, wherein a total thickness of Co layers in the (Co/Ni) multilayer film is equal to or larger than a total thickness of Ni layers.

11. The magnetic recording head according to claim 9, wherein
the reference layer is formed to be divided into a first region and a second region,
in the first region, a total thickness of Co layers is larger than a total thickness of Ni layers, and
in the second region, the total thickness of the Co layers is smaller than the total thickness of the Ni layers.

12. A magnetic recording device comprising:
a magnetic recording medium;
a magnetic recording head that records information in the magnetic recording medium;
a movable unit that relatively moves the magnetic recording medium and the magnetic recording head; and
a positioning control unit that positions the magnetic recording head in a predetermined recording position of the magnetic recording medium; and
a signal processing unit that supplies a recording signal to the magnetic recording head, wherein
the magnetic recording head includes:
a write pole;
a field generation layer that generates a high-frequency field; and
a reference layer that supplies spin torque to the field generation layer, and
when an externally applied field to the reference layer is represented as Hₑₓₜ, a magnetic anisotropy field of the reference layer is represented as Hₖ, and an effective demagnetizing field in a vertical direction of a film surface of the reference layer is represented as H_{d-eff}, conditions Hₑₓₜ−Hₖ+H_{d-eff}>0 and Hₑₓₜ+Hₖ−H_{d-eff}>0 are satisfied.

13. The magnetic recording device according to claim 12, wherein the field generation layer is set in a position where a magnetic field from the write pole is substantially parallel to a surface of the magnetic recording medium.
